(19) United States
(12) Patent Application Publication
(10) Pub. No.: US 2004/0109186 A1
(43) Pub. Date: Jun. 10, 2004

(54) Image forming apparatus and image data transforming method

(76) Inventors: Hidenori Shindoh, Tokyo (JP); Takao Okamura, Tokyo (JP); Osamu Kizaki, Saitama (JP); Kiyotaka Moteki, Tokyo (JP); Fumihiro Umetsu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/637,690

(22) Filed: Aug. 11, 2003

(30) Foreign Application Priority Data
Aug. 12, 2002 (JP) 2002-235035
Sep. 24, 2002 (JP) 2002-276678
Sep. 24, 2002 (JP) 2002-276679
Jul. 29, 2003 (JP) 2003-203079

(51) Int. Cl. G06F 3/12; G06F 15/00; G06F 13/00; G06F 9/28

(52) U.S. Cl. 358/1.13; 358/1.15; 358/1.16

(57) ABSTRACT

An image forming apparatus comprises hardware resources provided for use in image formation, programs performing respective processing related to the image formation, an image-data transforming unit transforming source image data into destination image data, an image-data memory unit having a source area in which the source image data is stored and a destination area in which the destination image data is stored, and an image-data management unit storing the source image data into the image-data memory unit. The image forming apparatus is configured so that while the image-data transforming unit transforms a preceding source image data stored in the image-data memory unit, the image-data management unit stores a following source image, subsequently transformed by the image-data transforming unit, into the image-data memory unit.

### BACKGROUND OF THE INVENTION

1. Field of The Invention

The present invention relates to an image forming apparatus and an image data transforming method.

2. Description of The Related Art

In recent years, the image forming apparatus in which the respective functions of the printer, the copier, the facsimile and the scanner are installed in the same housing has come to be known. Hereinafter, the image forming apparatus of this type will be called the multi-function system.

In the multi-function system, the four kinds of software respectively corresponding to the printer, the copy, the facsimile and the scanner are provided in addition to the display unit, the printing unit and the imaging unit provided in the same housing, and one of the printer, the copy, the facsimile and the scanner is operated by selecting one from among the four kinds of software.

Hence, the multi-function system transforms image data of one data format into image data of another data format in order to deal with image data of different kinds, and performs compression and decompression of image data in order to save the hardware resources of the image forming apparatus.

These transformations are performed in the transform library (which is software) with the development of a CPU (central. processing unit) in which the operating speed has improved and the digital signal processing is possible.

Moreover, there are some personal computers which perform the transformation of image data using the dedicated hardware.

Hereinafter, compression and decompression of image data will also be called the transformation.

A description will be given of the transformation performed by a conventional image forming apparatus. FIG. 41 is a sequence diagram for explaining the transform processing of a conventional image forming apparatus.

The sequence diagram indicates the transform processing which is performed by an image data transform unit, a hard disk drive (HDD), an image data management unit and a transform control unit in the conventional image forming apparatus.

In the transform processing of FIG. 41, a series of processings is repeated in which a predetermined unit of image data stored in the hard disk is read out, the read image data is transformed, and the transformed image data is written to the hard disk.

As shown in FIG. 41, the image data management unit reads the image data from the hard disk drive, and stores the image data in the memory area S (step S1 and step S2).

Next, the image data management unit sends a request to the transform control unit (step S3) so that the image data stored in the memory area S is transformed by the transform control unit, and the transformed image data is stored in the memory area D.

The transform control unit, which has received the request from the image data management unit, sends a request to the transform unit (step S4) so that the image data stored in the memory area S is transformed.

After the transform unit transforms the image data and the transformation is completed, the transform unit notifies to the transform control unit that the transformation of the image data is completed (step S5).

The transform control unit, which has received the notification from the transform unit, notifies to the image data management unit (step S6) that the transformation of the image data is completed. And the image data management unit saves the transformed image data, which is stored in the memory area D, to the hard disk (step S7 and step S8).

Next, the image data management unit reads the image data from the hard disk again, and stores the read image data in the memory area S (step S9 and step S10).

And the image data management unit sends a request to the transform control unit (step S11) so that the image data stored in the memory area S is transformed and the transformed image data is stored in the memory area D.

The transform control unit, which has received the request from the image data management unit, sends a request to the image data transform unit (step S12) so that the image data transform unit transforms the image data stored in the memory area S.

Thus, the series of processings is repeated at step S12 and subsequent steps in which a predetermined unit of image data stored in the hard disk is read out, the read image data is transformed, and the transformed image data is written to the hard disk.

However, the conventional image forming apparatus is placed in a waiting condition until the transforming process is completed by the image data transform unit.

Moreover, the conventional image forming apparatus is placed in a waiting condition until the reading/writing of the image data from/to the hard disk is completed by the image data management unit.

Moreover, the transforming time is not stabilized because the CPU performs not only the transforming process but also other processings, even if the CPU in which the operating speed has improved and the digital signal processing is possible is used. Especially the transforming process requires a lot of calculations to be performed, which will cause the transforming time to be remarkably increased.

Therefore, in many cases in which the real-time processing, such as the facsimile and the copy, is required, the load of the CPU is increased and the productivity is decreased.

Furthermore, even if the dedicated hardware is used, the capacity of the CPU may have the margin depending on the processing type. The image processing is a major processing for the conventional image forming apparatus, unlike the personal computer. Even when the CPU capacity has the margin, the conventional image forming apparatus does not operate at peak capacity, and the productivity in such a case is low.

With the conventional technology, one cannot efficiently make use of the function of the latest image forming apparatus having the sheet delivery speed of 100 or more sheets per minute. The conventional image forming apparatus still has the problem in that the efficiency of the transforming of image data is low.

### SUMMARY OF THE INVENTION

An object of the present invention is to provide an improved image forming apparatus in which the above-described problems are eliminated.

Another object of the present invention is to provide an image forming apparatus in which the efficiency of the transforming of image data has improved.

Another object of the present invention is to provide an image data transforming method in which the efficiency of the transforming of image data has improved.

The above-mentioned objects of the present invention are achieved by an image forming apparatus comprising: a plurality of hardware resources provided for use in image formation; a plurality of programs performing respective processing related to the image formation; an image-data transforming unit transforming source image data into destination image data; an image-data memory unit having a source area in which the source image data is stored and a destination area in which the destination image data is stored; and an image-data management unit storing the source image data into the image-data memory unit, wherein the image forming apparatus is configured so that while the image-data transforming unit transforms a preceding source image data stored in the image-data memory unit, the image-data management unit stores a following source image, subsequently transformed by the image-data transforming unit, into the image-data memory unit.

The above-mentioned objects of the present invention are achieved by an image data transforming method for an image forming apparatus including a plurality of hardware resources provided for use in image formation and a plurality of programs performing respective processing related to the image formation, the method comprising the steps of: providing an image-data memory unit having a source area in which source image data is stored and a destination area in which destination image data is stored; storing the source image data into the image-data memory unit; transforming the source image data stored in the image-data memory unit, into the destination image data; wherein the storing step and the transforming step are configured so that while a preceding source image data stored in the image-data memory unit is transformed, a following source image, subsequently transformed by the transforming step, is stored into the image-data memory unit.

As described above, it is possible for the present invention to provide the image forming apparatus and the image data transforming method in which the efficiency of the image data transformation has remarkably improved.

### BRIEF DESCRIPTION OF THE DRAWINGS

Other objects, features and advantages of the present invention will be apparent from the following detailed description when read in conjunction with the accompanying drawings.

FIG. 1 is a block diagram of one preferred embodiment of a multi-function system according to the present invention.

FIG. 2 is a block diagram of the composition of the multi-function system of the present embodiment.

FIG. 3 is a block diagram of an MLB in the multi-function system of the present embodiment.

FIG. 4 is a diagram for explaining the transforming functions of the MLB.

FIG. 5 is a diagram for explaining the flow of image data in the MLB.

FIG. 6 is a diagram showing image data areas in the present embodiment.

FIG. 7 is a diagram showing the condition of the image data areas when the transforming process is performed.

FIG. 8 is a diagram showing the condition of the image data areas when the transforming process is performed.

FIG. 9 is a block diagram of an MEU in the multi-function system of the present embodiment.

FIG. 10 is a diagram for explaining a state transition.

FIG. 11 is a flowchart for explaining the state transition.

FIG. 12 is a flowchart for explaining an image data transforming process of the present embodiment.

FIG. 13 is a flowchart for explaining an image data transforming process of the present embodiment.

FIG. 14 is a sequence diagram for explaining first pattern processing of the present embodiment.

FIG. 15 is a diagram showing the condition of the image data areas when the first pattern processing is performed.

FIG. 16 is a sequence diagram for explaining second pattern processing of the present embodiment.

FIG. 17 is a diagram for explaining the condition of the image data areas when the second pattern processing is performed.

FIG. 18 is a sequence diagram for explaining third pattern processing of the present embodiment.

FIG. 19 is a diagram for explaining the condition of the image data areas when the third pattern processing is performed.

FIG. 20 is a diagram for explaining a state transition.

FIG. 21 is a flowchart for explaining processing of a run thread.

FIG. 22 is a flowchart for explaining processing of a resource management unit.

FIG. 23 is a diagram showing a table used to select the MLB or the transform library.

FIG. 24 is a diagram for explaining calculation of a total of transform amounts.

FIG. 25 is a flowchart for explaining processing of the run thread.

FIG. 26 is a flowchart for explaining processing of the resource management unit.

FIG. 27 is a flowchart for explaining processing of the run thread.

FIG. 28 is a sequence diagram for explaining processing when the MLB is used.

FIG. 29 is a sequence diagram for explaining processing when the transform library is used.

FIG. 30 is a flowchart for explaining of the run thread and the created task.

FIG. 31 is a diagram for explaining a state transition.

FIG. 32 is a flowchart for explaining processing of the resource management unit.

FIG. 33 is a diagram for explaining a method of rearrangement of image data between the MLB queue and the library queue.

FIG. 34 is a diagram for explaining a method of rearrangement of image data between the MLB queue and the library queue.

FIG. 35 is a diagram for explaining a method of rearrangement of image data between the MLB queue and the library queue.

FIG. 36 is a diagram for explaining a method of rearrangement of image data between the MLB queue and the library queue.

FIG. 37 is a flowchart for explaining processing of the resource management unit.

FIG. 38 is a diagram for explaining interruption of image data in the queue.

FIG. 39 is a diagram for explaining a method of continuous management of image data.

FIG. 40 is a diagram for explaining a method of continuous management of image data.

FIG. 41 is a sequence diagram for explaining processing of a conventional image forming apparatus.

### DETAILED DESCRIPTION OF PREFERRED EMBODIMENTS

A description will now be provided of the preferred embodiments of the present invention with reference to the accompanying drawings.

In the following description, encoded or transformed image data will also be called the image data, unless otherwise specified. Moreover, encoding and decoding of image data, etc., which performs a certain processing of image data will also be called the image data transformation.

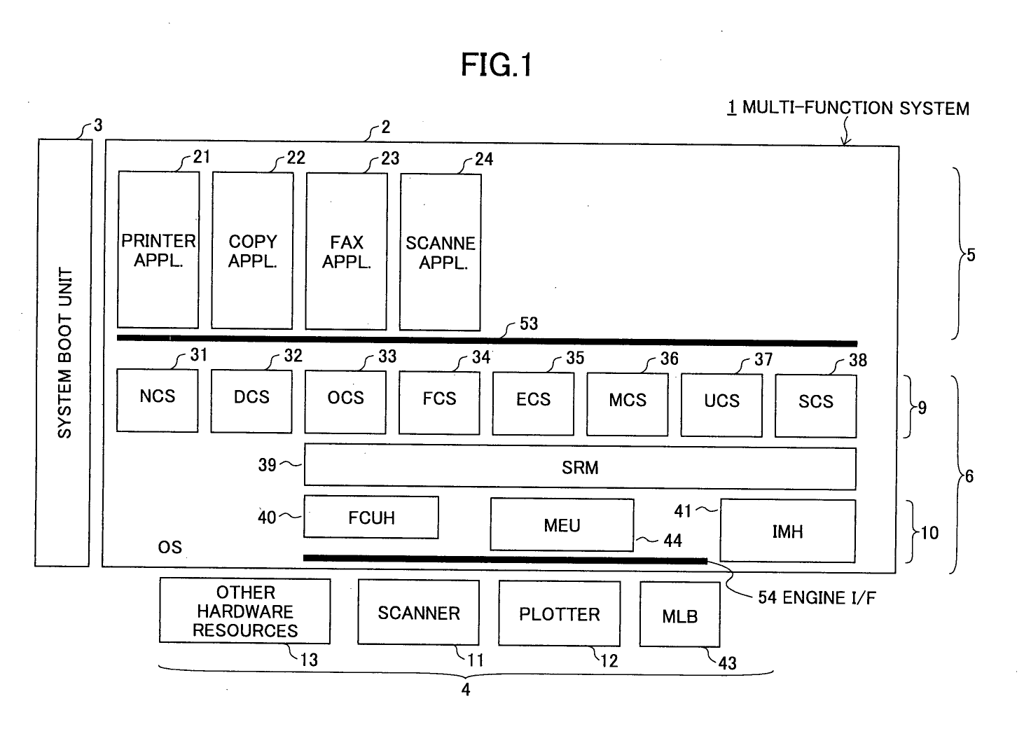

FIG. 1 shows one preferred embodiment of the multi-function system according to the present invention.

As shown in FIG. 1, the multi-function system 1 includes the software group 2, the system boot unit 3, and the hardware resources 4.

The system boot unit 3 is first loaded when the power switch (not shown) of the multi-function system 1 is turned ON, so that the system boot unit 3 starts execution of the application layer 5 and the platform layer 6.

For example, the system boot unit 3 reads the programs of the application layer 5 and the platform layer 6 from the hard disk drive (HDD), which corresponds to the external storage device. Then the system boot unit 3 transfers the read programs to the memory areas, and starts executions of the programs.

The hardware resources 4 include the scanner 11, the plotter 12, the MLB 43 (which corresponds the image data transform unit), and the other hardware resources 13 such as ADF (auto document feeder), etc.

The software group 2 includes the application layer 5 and the platform layer 6 which are operated on the operating system (OS), such as UNIX (registered trademark). The application layer 5 includes the programs which perform respective processings specific to the user services concerning the image formation, such as the printer, the copy, facsimile, and the scanner.

The application layer 5 includes the printer application 21 which is the application program for the printer, the copy application 22 which is the application program for the copier, the facsimile application 23 which is the application program for the facsimile, and the scanner application 24 which is the application program for the scanner.

Moreover, the platform layer 6 includes the control service layer 9 which interprets the processing request from the application layer 5, and generates the acquisition request of hardware resources 4, the system resource manager (SRM) 39 which manages one or more hardware resources 4, and arbitrates the acquisition request from the control service layer 9, and the handler layer 10 which manages the hardware resources 4 according to the acquisition request from SRM 39.

The control service layer 9 includes one or more service modules which may include network control service (NCS) 31, delivery control service (DCS) 32, operation panel control service (OCS) 33, facsimile control service (FCS) 34, engine control service (ECS) 35, memory-control service (MCS) 36, user information control service (UCS) 37, and system control service (SCS) 38.

In addition, the platform layer 6 is provided to have API 53 which makes it possible to receive the processing request from the application layer 5 according to a pre-defined function.

The OS carries out parallel execution of each software of the application layer 5 and the platform layer 6 as a process.

The process of NCS 31 offers the service which can be used in common to the application which needs network I/O, distributes the data received by each protocol from the network side to each application, or performs agency at the time of transmitting the data from each application to the network side.

For example, NCS 31 controls the data communication with a network device connected through the network, by using the HTTP (hypertext transfer protocol) according to the HTTPD (hypertext transfer protocol daemon).

The process of DCS 32 controls distribution of the accumulated documents etc.

The process of OCS 33 controls the operation panel which is the interface between the operator and the multi-function system 1 used as the unit of communication of information.

The process of FCS 34 provides the application API for performing the facsimile transmission and reception through the PSTN or ISDN network used by the application layer 5, the registration/access of the various facsimile data managed by the memory for backup, the facsimile reading, the facsimile reception printing, etc.

The process of ECS 35 controls the engine units, such as the scanner 11, the plotter 12, and the other hardware resources 13.

The process of MCS 36 performs the memory control of the acquisition and releasing of the memory and release, the use of HDD, etc.

The process of UCS 37 manages the user information.

The process of SCS 38 processes the application management, the operation panel control, the system screen display, the LED display, the hardware-resources management, the interruption application control, etc.

The process of SRM 39 performs control of the system and management of the hardware resources 4 in association with SCS 38.

For example, according to the acquisition request using the hardware resources 4 from the high order layer, the process of SRM 39 arbitrates the request and carries out the execution control.

Specifically, the process of SRM 39 determines whether the hardware resources 4 to which the acquisition request is sent can be used (or whether the hardware resources 4 are already used by another acquisition request). If the use of the hardware resources 2 is possible, the process of SRM 39 will notify to the high order layer that the hardware resources 4 to which the acquisition request is sent can be used.

Moreover, the process of SRM 39 performs the scheduling of the acquisition request from the high order layer for using the hardware resources 4, and carries out the contents of the request (for example, paper conveyance with the printer engine, imaging operation, memory reservation, file generating, etc.) directly.

Moreover, the handler layer 10 includes the facsimile control-unit handler (FCUH) 40 which manages the facsimile control unit (FCU), the image memory handler (IMH) 41 which manages the assignment of the memory to the process and the memory assigned to the process, and the MEU 44 which performs control of MLB 43.

SRM 39 and FCUH 40 send the processing request to the hardware resources 4 using the engine I/F 54 which makes it possible to send the processing request to the hardware resources 4 according to the pre-defined function.

MEU 44 receives the transforming request of the image data from IMH 41 (corresponding to the image data management unit), and performs the transformation of the image data by using MLB 43.

The multi-function system 1 can process the common processing, shared by the respective applications, in the platform layer 6 in a concentrated manner.

Next, a description will be given of the hardware composition of the multi-function system 1.

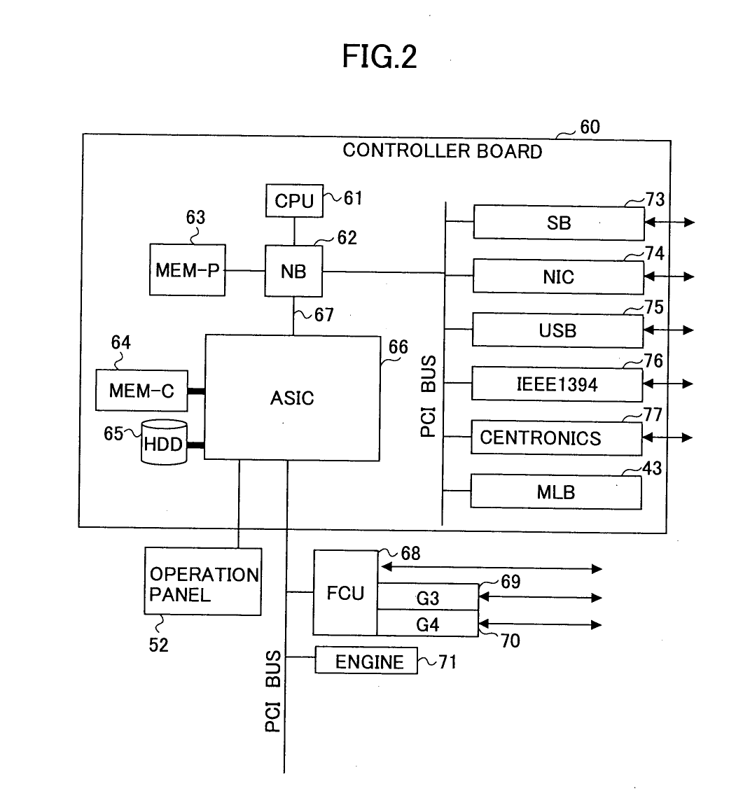

FIG. 2 shows the hardware composition of one preferred embodiment of the multi-function system 1 according to the present invention.

The multi-function system 1 includes the controller board 60, the operation panel 52, FCU 68, and the engine 71.

FCU 68 includes the G3 standard fax unit 69 and the G4 standard fax unit 70.

The controller board 60 includes CPU 61, ASIC 66, HDD 65, the system memory (MEM-P) 63, the local memory (MEM-C) 64, the north bridge (NB) 62, the south bridge (SB) 73, NIC (network interface card) 74, the USB device 75, the IEEE1394 device 76, the Centronics device 77, and MLB 43.

The operation panel 52 is connected to ASIC 66 of the controller board 60.

Moreover, SB 73, NIC 74, the USB device 75, the IEEE1394 device 76, the Centronics device 77, and MLB 43 are connected to NB 62 by the PCI (peripheral component interconnect) bus.

MLB 43 is a chip which is connected with the multi-function system 1 through the PCI bus.

Moreover, MLB 43 transforms the image data inputted from the multi-function system 1, and outputs the transformed image data or the encoded image data to the multi-function system 1.

Moreover, FCU 68, the engine 71, and the plotter 72 are connected to ASIC 66 of the controller board 60 by the PCI bus.

In the controller board 60, the local memory 64, HDD 65, etc. are connected to ASIC 66, and CPU 61 and ASIC 66 are connected to ASIC 66 through NB 62 which is the CPU chip set.

Thus, if CPU 61 and ASIC 66 are connected through NB 62, when the interface of CPU 61 is not exhibited, it can resolve the problem.

Moreover, ASIC 66 and NB 62 are connected through AGP (accelerated graphics port) 67, not through the PCI bus. In order to carry out execution control of one or more processes which constitute the application layer 5 and the platform layer 6 of FIG. 1, ASIC 66 and NB 62 are connected not through the low-speed PCI bus but through AGP 67. It is thus possible to prevent the lowering of the performance.

CPU 61 performs the control of the whole multi-function system 1. CPU 61 starts execution of NCS 31, DCS 32, OCS 33, FCS 34, ECS 35, MCS 36, UCS 37, SCS 38, SRM 39, FCUH 40, IMH 41 and MEU 44 as a process, and performs the execution of each process on the OS. Moreover, CPU 61 starts execution of the printer application 21, the copy application 22, the facsimile application 23, and the scanner application 24 which constitute the application layer 5.

NB 62 is the bridge which is provided for connecting CPU 61, the system memory 63, SB 73 and ASIC 66.

The system memory 63 is a memory used for image drawing of the multi-function system 1.

SB 73 is the bridge which is provided for connecting NB 62, and the PCI bus and the peripheral device.

Moreover, the local memory 64 is the memory used as the image buffer for the copying, and the encoding buffer.

ASIC 66 is an application-specific IC for image-processing uses including the hardware for image processing.

HDD 65 is the storage for performing accumulation of images, accumulation of document data, accumulation of programs, accumulation of font data, accumulation of forms, etc.

Moreover, the operation panel 52 is a control unit which displays the operational messages to the operator and receives the input operation from the operator.

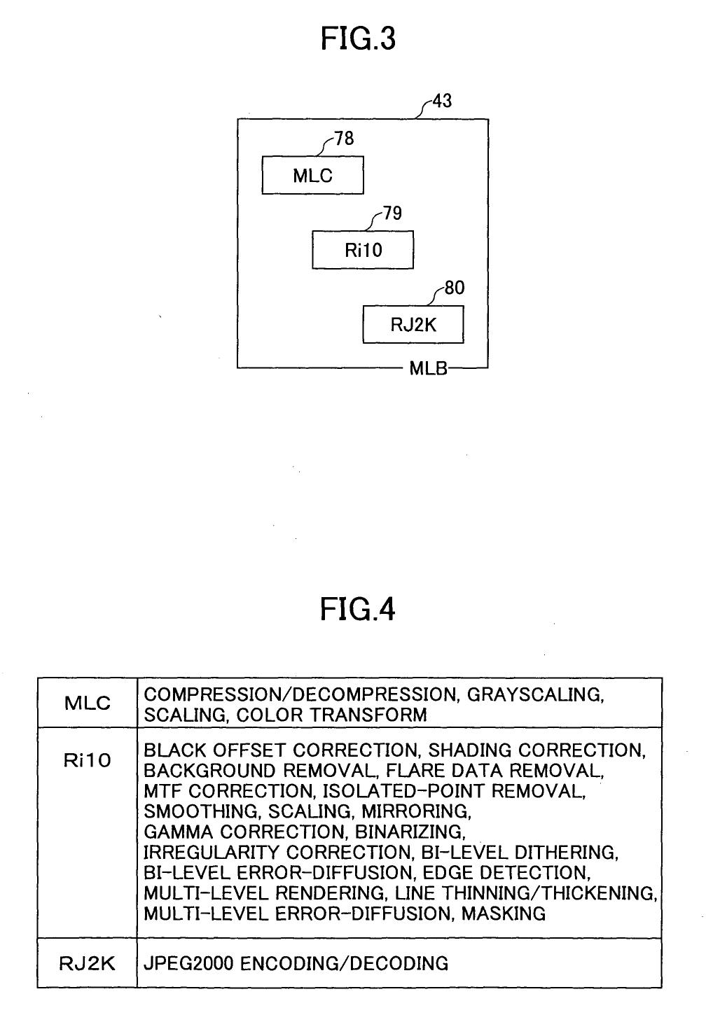

Next, a description will be given of MLB 43 with reference to FIG. 3.

As shown in FIG. 3, MLB 43 includes MLC 78, Ri10 79 (which will be referred to as Ri 79, in order to avoid confusion), and RJ2K 80.

Each of MLC 78, Ri 79, and RJ2K 80 is a chip having the functions of transformation of image data. MLC 78 is the chip that is attached to MLB 43 as the standard part, and Ri 79 and RJ2K 80 are the option chips which can be attached optionally.

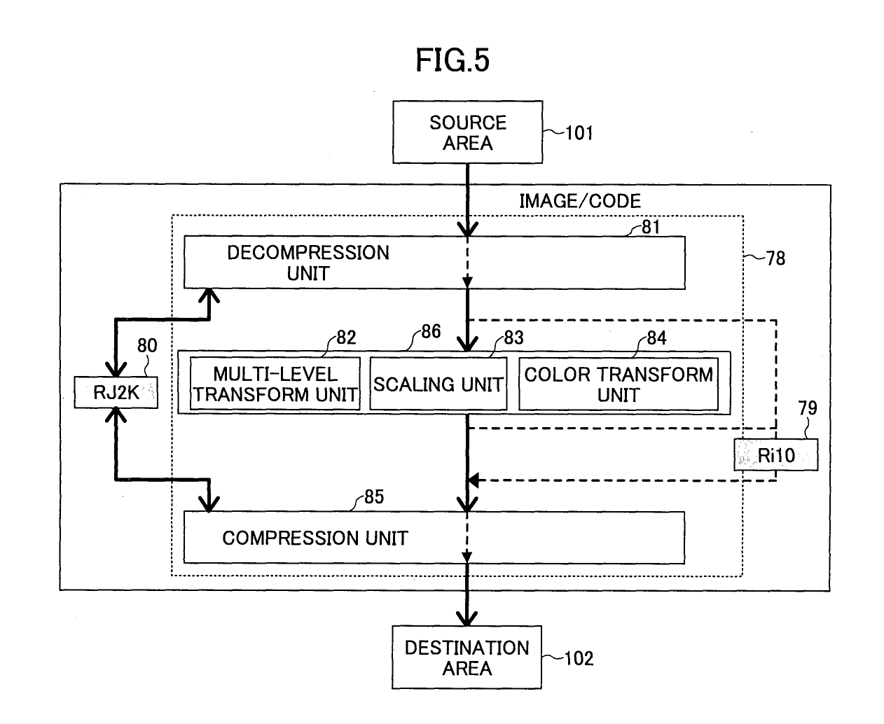

A description will be given of the transformation functions of the chips MLC 78, Ri 79 and RJ2K 80 with reference to FIG. 4.

As shown in FIG. 4, the functions of MLC 78 include compression, decompression, grayscaling, scaling, and color transform. The functions of Ri 79 include black offset correction, shading correction, background removal, flare data removal, MTF correction, isolated-point removal, smoothing processing, enlarging or contracting, mirroring, gamma correction, binarizing, irregularity correction, bi-level dithering, bi-level error diffusion, edge detection, multi-level rendering, line thinning/thickening, multi-level error diffusion, and mask processing. The functions of RJ2K 80 include JPEG2000 encoding and decoding.

FIG. 5 shows the flow of image data in MLB 43 when the image data is transformed.

In the following description, in order to express the transfer of image data intelligibly, it may be expressed as the input or the output. Moreover, the transformation of image data may also be expressed as decompression, compression, encoding, and decoding.

First, a description will be given of the internal composition of MLC 78.

MLC 78 includes the decompression unit 81, the multi-level transform unit 82, the scaling unit 83, the color transform unit 84, and the compression unit 85.

The multi-level transform unit 82 performs the multi-level transformation. The scaling unit 83 changes the size of the image. The color transform unit 84 changes the color of the image. The decompression unit 81 transforms the compressed image data into the original-size image data. The compression unit 85 compresses the image data.

Moreover, the decompression unit 81 and the compression unit 85 are adapted to be in conformity with the respective formats of JPEG, MH/MR/MMR and NFC1.

In addition, suppose that the multi-level transform unit 82, the scaling unit 83, and the color transform unit 84 are collectively called the transform unit 86.

Ri 79 performs the transformation of the image data received from the decompression unit 81 and the transformation of the image data received from the transform unit 86.

RJ2K 80 performs the encoding and decoding of the image data, received from the decompression unit 81 or the compression unit 85, in accordance with the JPEG2000 standard.

In addition, the source area 101 is the memory area in which the image data to be transformed is stored, and the destination area 102 is the memory area in which the transformed image data is stored.

These memory areas are the memory areas on the local memory 64 or the system memory 62 which is acquired by IMH 42.

The local memory 64 and the system memory 62 may be expressed as the memory in the following description.

A description will be given of the actual processing for performing image transformation efficiently. For the sake of convenience of description, the actual processing is roughly divided into three processings.

A description will be given of the first processing to use the memory and HDD at the time of transforming the image data.

In order to make the understanding of this processing easy, the fundamental contents of processing are explained.

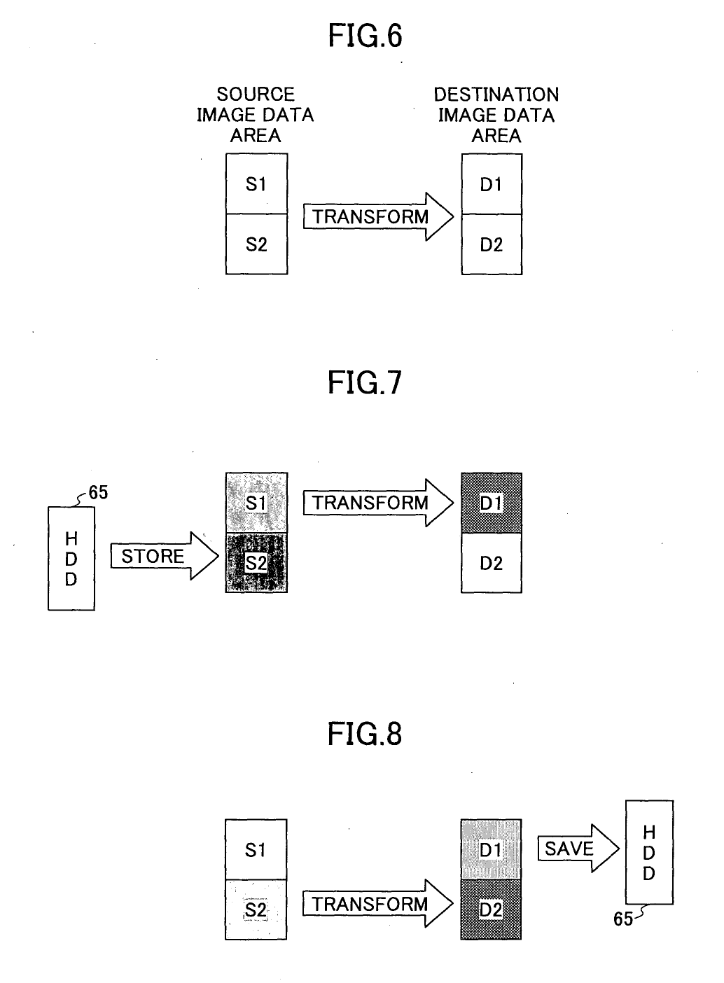

First, the memory will be described with reference to FIG. 6.

As shown in FIG. 6, the memory which stores the image data is composed of the two source areas (S1, S2) in which the image data to be transformed is stored, and the two destination areas (D1, D2) in which the transformed image data is stored.

Alternatively, the memory may be composed of three or more areas for each of the source areas and the destination areas. However, in order to simplify the subsequent description, suppose that the memory in the present embodiment is composed of two areas for each of the source areas and the destination areas.

Moreover, the size of the image data area is arbitrary. However, if the size is an integral multiple of the greatest size that is capable of reading and writing at once of HDD 65, it will become possible to further increase the efficiency of the transform processing.

Next, the actual transforming performed using the image data area mentioned above is explained.

A description will be given of the condition of the image data areas in the transforming with reference to FIG. 7 and FIG. 8.

FIG. 7 shows the condition of the image data areas when the transforming process is. In FIG. 7, the image data which is transformed is the image data stored in the area S1, and the transformed image data is stored in the area D1.

While the image data stored in the area S1 is being transformed, the image data to be transformed subsequently is stored in the area S2. Thereby, the next transforming can be performed immediately after the transforming of the area S1 is completed, without waiting for the end of the processing in which the image data is stored in the area S2.

FIG. 8 shows the condition of the image data areas when the image data stored in the memory is transformed and stored in the memory, and the image data stored in the memory is saved to HDD 65. In FIG. 8, the image data to be transformed is the image data stored in the area S2, and the transformed image data is stored in the area D2. Moreover, the image data stored in the area S1 is the already transformed image data.

While the image data of the area S2 is transformed and it is stored in the area D2, the image data of the area D1 which is the transformed image data is saved to HDD 65. Thereby, the saving processing to HDD 65 can be performed immediately without waiting for the end of the transforming of the area S2.

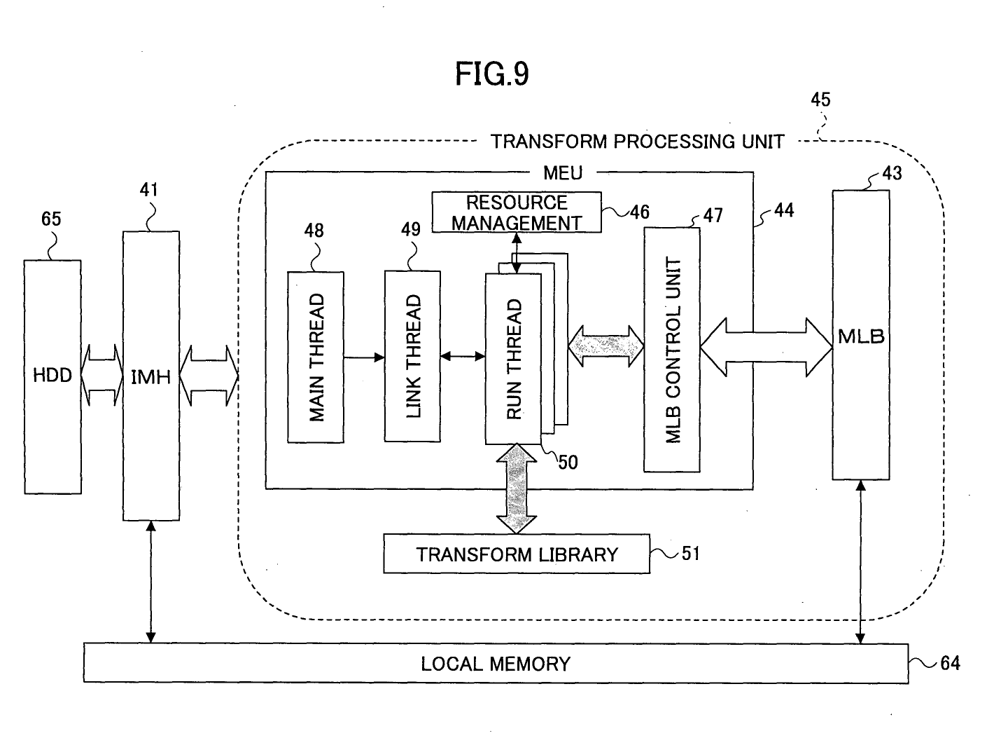

Next, a description will be given of the image data transforming unit 45 which performs the above-mentioned image data transforming with reference to FIG. 9.

FIG. 9 shows the MEU 44 included in the image data transforming unit 45, IMH 41, HDD 65, and the local memory 64.

As described above, MLB 43 is the hardware which performs the transforming of image data in the JPEG, JPEG2000, MH/MR/MMR or NFC1 format.

Moreover, the image data transforming unit 45 includes MEU 44, MLB 43, and the transform library 51.

Among these, MEU 44 has the main thread 48, the link thread 49, the run thread 50, and the resource management unit 46.

The main thread 48 is the thread which performs the exchange with IMH 41, and notifies the request from IMH 41 etc. to the link thread 49.

The link thread 49 is the thread which manages the run thread 50. For example, when there are two or more run threads 50 some of which are performing the transforming of image data, the link thread 49 selects the run thread 50 which does not perform the transforming, and causes the selected run thread to perform the transforming requested from the main thread 48.

The run thread 50 is the thread which performs the transforming by using the MLB control unit 47 which is the thread, and the transform library 51.

Moreover, two or more run threads 50 are provided, in order to allow execution of the transformation of two or more image data, since the run thread 50 is the thread which performs the transforming of one image data at a time.

The resource management unit 46 is a module which manages the resources of the transform library 51 and MLB 43.

The transform library 51 is the library which performs the transforming by software.

The transform library 51 includes the functions of transforming, and the run thread 50 can transform the image data by calling the functions of the transform library 51.

Generally, the thread means the smallest unit of processing when the OS carries out parallel execution of the respective programs as the processes and the processing is divided into a plurality of threads. Moreover, the thread in the present embodiment is considered as the thread which can also transmit and receive a mail. In addition, depending on the kind of the OS, the mail is also called message and contains the information of instructions, data, etc. which are exchanged among the objects, such as the threads.

Therefore, the exchange of information among the main thread 48, the link thread 49, the run thread 50, and the MLB control unit 47, which are all the threads, is usually performed by means of the mail.

When the transforming is performed by the MLB 43, the run thread 50 uses the mail in order to transmit the necessary information to the MLB 43 via the MLB control unit 47.

Moreover, when the transforming is performed with the transform library 51, which is not the thread, the run thread 50 can perform the transforming with the transform library 51 directly by using the function call.

Moreover, since MLB 43 has the hardware containing the arithmetic unit required for the transforming only, it can carry out the transforming by itself, independently with the transform library 51.

Next, a description will be given of the processing of the run thread 50 and the processing of the MLB control unit 47.

First, the processing of the run thread 50 will be explained.

By the request from the link thread 49, the run thread 50 generates the task and acquires the resource required for the task. Then, the run thread 50 will perform processing which notifies that the transformation is completed to IMH 41 through the link thread 49, if it requires that the transforming should be performed from the MLB control unit 47 and the end of the transformation is notified from the MLB control unit 47.

Next, the processing of the MLB control unit 47 will be explained.

By the request from the run thread 50, the MLB control unit 47 performs processing which notifies that the transformation of the image data is completed to the run thread 50, after setting the parameter about the transformation of the image data to the register of MLB 43 or completing the transformation of the image data by MLB 43.

The run thread 50 and the MLB control unit 47 perform the processing by using the state which expresses the state of each thread, respectively.

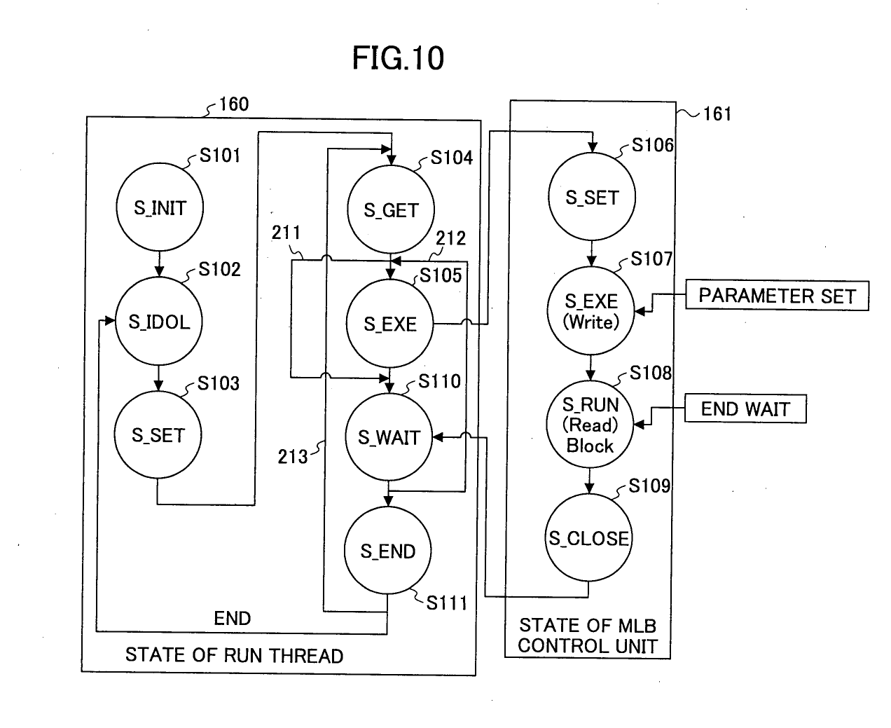

FIG. 10 is a diagram for explaining changes of the states.

The state transition diagram 160 of the run thread 50 and the state transition diagram 161 of the MLB control unit 47 are shown in FIG. 10.

The state of the run thread 50 serves as S_INIT of step S101 which shows the state of performing initialization processing first. This initialization processing is processing to which initialization of the variables to be used is carried out, for example.

The state of the run thread 50 which completed initialization changes to S_IDOL of step S102. The processing with this substantial S_IDOL is the state which nothing carries out.

If the image data transformation request is notified to the run thread 50 from IMH 41 as this state, the state will change to S_SET of step S103. This state is the state for which processing which generates the task according to the request is performed.

Next, the state of the run thread 50 serves as S_GET of step S104 which is the state which acquires the resource required for the task which is previously generated by the run thread 50.

If the state becomes S_GET, the following state will be whether the resource required for the task was acquirable, and will be divided into two.

First, the case where the resource is acquirable is explained.

At the state S_GET, when the run thread 50 is able to acquire the resource, the state changes to S_EXE of step S105, and the run thread 50 performs the image data transformation request to the MLB control unit 47. Thereby, the state changes to S_WAIT of step S110. This state is the state which waits for the response from the MLB control unit 47.

And if there is the response from the MLB control unit 47, the state changes to S_EXE of step S105 again, when the transforming is continued, and when there is no necessity for continuation, it will change to S_END of step S111.

If the state changes to S_END, the run thread 50 will determine whether the task is ended or the following task is performed.

When ending the task, since processing is completed, the state changes to S_IDOL.

When performing the following task, as shown in the arrow 213, the state changes to S_GET again.

The above is the changes of the states when the state is S_GET and it is able to acquire the resource.

When the state is S_GET and the resource is not able to be acquired, as shown in the arrow 211 in FIG. 10, the state does not change to S_EXE of step S105, but changes to S_WAIT of step S110.

If waiting and the resource become acquirable until the acquisition of the resource is attained as the state, as shown in the arrow 212, the state will change to S_EXE of step S105. Changes of the state after this become the same as changes of the state when the resource is acquirable.

Next, the state transition diagram 161 of the MLB control unit 47 is explained.

By the request from the run thread 50, the state of the MLB control unit 47 serves as S_SET which is the state which generates the task of step S106.

Next, the state of the MLB control unit 47 serves as S_EXE of step S107, and the MLB control unit 47 sets the parameter to the register of MLB 43, in order to transform the image data.

Thereby, the state changes to S_RUN of step S108 which shows under execution of processing.

Processing of the MLB control unit 47 is locked and the end waiting of the transforming occurs until the transforming of MLB 43 is completed, since the MLB control unit 47 uses the system call of OS at this time.

After the transforming of MLB 43 is completed, the state of the MLB control unit 47 serves as S_CLOSE of step S109 which shows the end of the transforming.

And at this time, the MLB control unit 47 notifies the end of the transformation to the run thread 50, and ends processing.

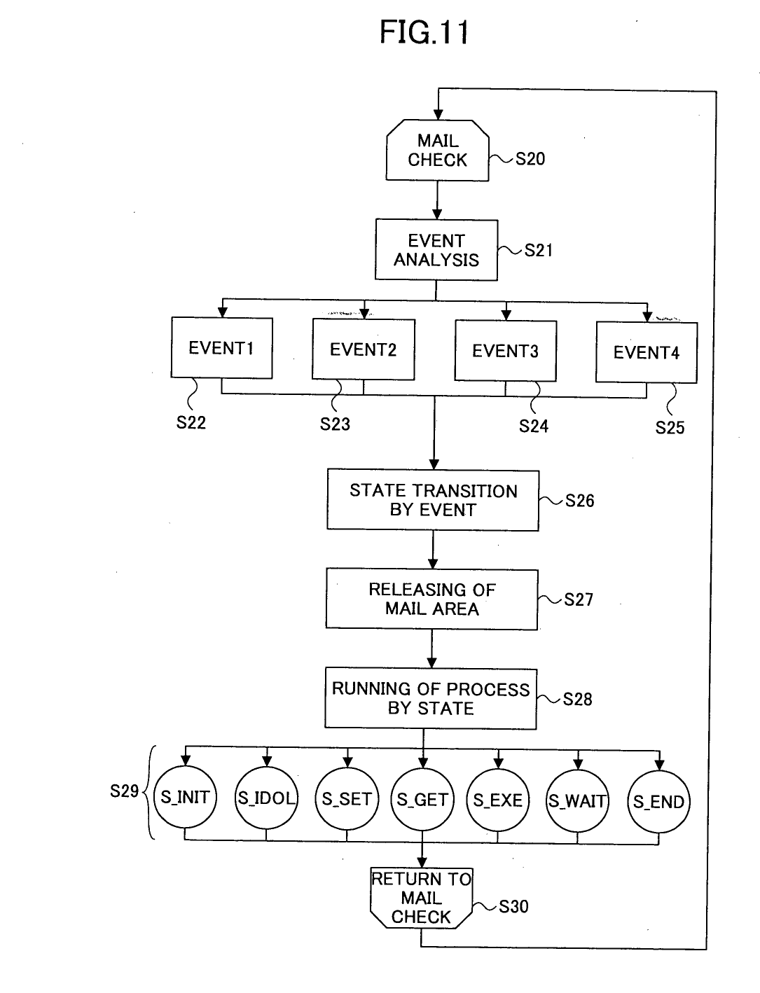

A description will be given of the changes of the state of the run thread 50 by using the flowchart of FIG. 11.

At step S20, the run thread 50 checks a mail.

In this case, with the mail receiving command with the time-out, according to the above-mentioned state, make it wait, and it is sufficient and mail is carried out.

This time-out value will presuppose that it is infinite, if the state is S_WAIT, and if it is S EXE, it is set to 0.

If the mail is received, the run thread 50 will be step S21, and will analyze the contents of the event from the received mail.

According to the contents of the event, the run thread 50 processes step S22, step S23, step S24, or step S25.

And the run thread 50 makes the state change by the event at step S26.

In addition, in step S26, when the state is except S_WAIT, it memorizes that the run thread 50 held the information on mail, and it received mail using the flag etc. since the run thread 50 performed a certain processing.

Since the contents of mail become unnecessary by the above processing, the run thread 50 releases the mail area.

This processing is processing usually performed, in order to prevent leaving mail as it is and the availability of the memory becoming less, since mail generally consists of the memory storage the contents of the header and mail were indicated to be.

Next, the run thread 50 performs processing of step S29 by the state mentioned above at step S28.

And the run thread 50 performs mail check processing of step S20 again after performing processing according to the one state.

Thus, processing of the event by mail and changes of the state are performed.

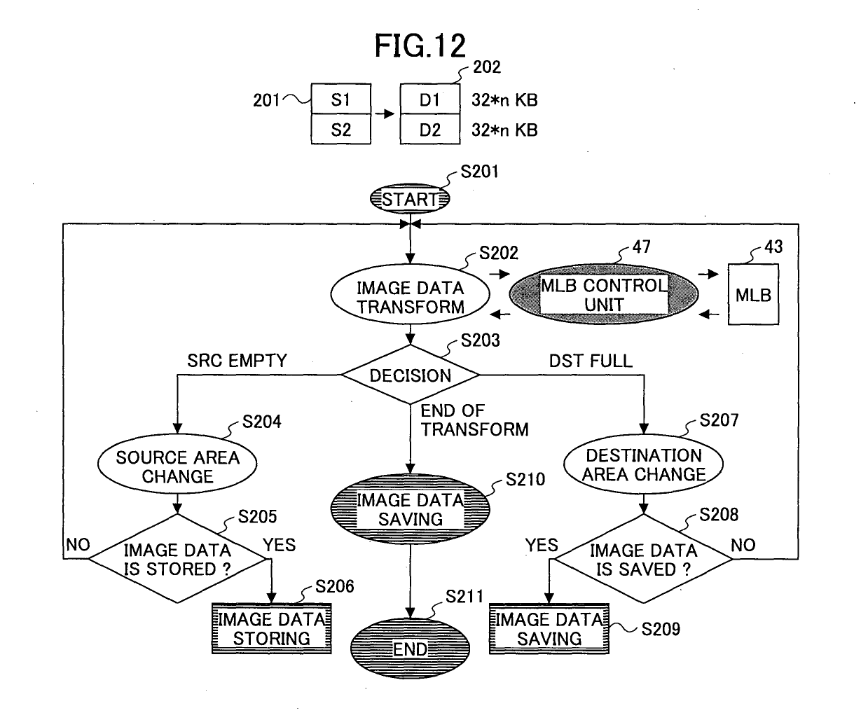

Next, a description will be given of the transforming of the image data with reference to FIG. 12.

FIG. 12 is a flowchart for explaining the processing which is performed by the IMH 41, the run thread 50, and the MLB control unit 47. The memory composition of this embodiment in which the image data is stored is the image data areas 201 and 202, similar to the memory composition shown in FIG. 6.

Moreover, the size of the image data area is set to 32 KB (kilobyte) which is the unit that can be accessed to the HDD 65 in this case, and the image data area size may be set to an integral multiple of 32 KB where “n” is an integer.

As shown in FIG. 12, it is requested to MEU 44 by IMH 41 at step S201 that the image data is stored the image data in S1 or S2, and the stored image data is transformed.

The run thread 50, which has received the request, requests at step S202 the MLB control unit 47 to transform the image data, and the MLB control unit's 47 transforming the image data by MLB 43 and completing the transformation, it notifies that the transformation is completed to the run thread 50.

The run thread 50, after the end of the transformation is notified, determines whether the transformation of the image data is continued at step S203.

As the result of the determination of step S203, there are three different cases.

Among these cases, a description will be given of the case where it branches to the source area vacant (SRC EMPTY).

The case where the image data area transformed is determined to be vacant branches to the source area vacant (SRC EMPTY).

In this case, the run thread 50 changes the image data area between the two areas at step S204.

This change is processing in which the transformation object domain is changed to the area S2, if the area which became the candidate for the transformation like the point is the area S1.

If change processing is performed, the run thread 50 will be step S205, and will determine whether the image data is stored.

By this judgment, still, in a certain case, processing progresses to step S206, the image data to transform is step S206, and IMH 41 stores the image data.

Since IMH 41 and the run thread 50 are another threads, this storing processing is performed independently apart from processing of the run thread 50.

It returns to judgment processing of step S205, and when it is determined that it is not necessary to store the image data at step S205, the run thread 50 advances processing to step S202 again.

Next, a description will be given of the processing in the case of branching to DST FULL at step S203.

The case where it is determined that the image data is stored in the area D1 or the area D2 branches to DST FULL.

In this case, the run thread 50 changes the image data area between the two areas at step S207.

This change is processing in which the object domain is changed to the area D2, if the area used as the object in which the data transformed, for example is stored is the area D1.

If change processing is performed next, the run thread 50 will be step S208, and will determine whether the image data is saved.

By this judgment, when saving the image data, processing progresses to step S209, and at step S209 IMH 41 saves the image data. Since IMH 41 and the run thread 50 are different threads, it is carried out independently apart from processing of the run thread 50.

It returns to judgment processing of step S208, and when the run thread 50 determines that it is not necessary to save the image data at step S208, processing is again advanced to step S202.

Next, a description will be given of the processing in the case of being determined as the transformation end at step S203.

After the transformation of the image data is completed, IMH 41 saves the image data at step S210, and processing is ended at step S211.

Although the above is the flowchart which shows the transforming, the image data which has the header may be transformed depending on the kind of image data to transform.

This header is prepared in the head portion of the image data of the FAX and JPEG system, and the contents are the length of the image data etc.

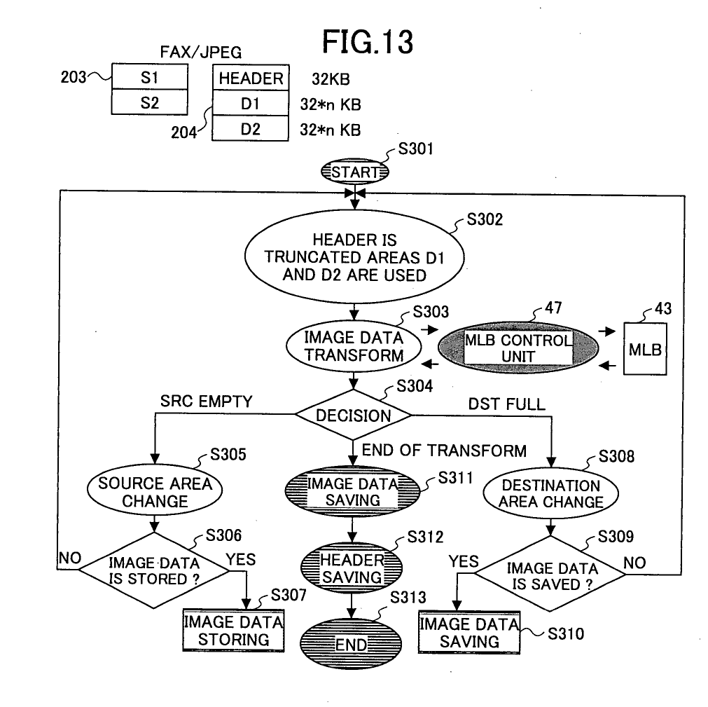

A description will be given of the image data transforming in this case with reference to FIG. 13.

In the flowchart of FIG. 13, two additional steps S302 and S312 are inserted to the flowchart of FIG. 12.

Moreover, although the image data area 203 is the same as FIG. 12, the image data area 204 includes the header area, the area D1, and the area D2.

As in the flowchart of FIG. 13, at step S301, IMH 41 requests to MEU 44 that the image data is stored in the memory and the stored image data is transformed similar to the case of FIG. 12.

The following step S302 is the processing performed when the request is received first.

Since the header is attached after all the transformation is completed, this processing is processing only whose part of the header shifts the write-in starting position of the image data at the time of storing the transformed image data in a part for the header of the image data area 204.

After the processing of step S302 is completed, the areas D1 and D2 are used at the following steps S303-S311 similar to the flowchart of FIG. 12.

And the header which is previously stored is saved by IMH 41 at step S312, and the processing is ended at step S313.

Next, the processing performed by the above-mentioned flowchart is explained using the sequence diagram.

In addition, since the thread mentioned above and MLB 43 are parallel and processing is performed, the timing which stores the image data changes with transforming time of MLB 43. Therefore, a description will be given of the cases of the three patterns.

The first pattern is the case that the transforming time of MLB 43 is larger than the time which added time to save time to store the image data and the image data.

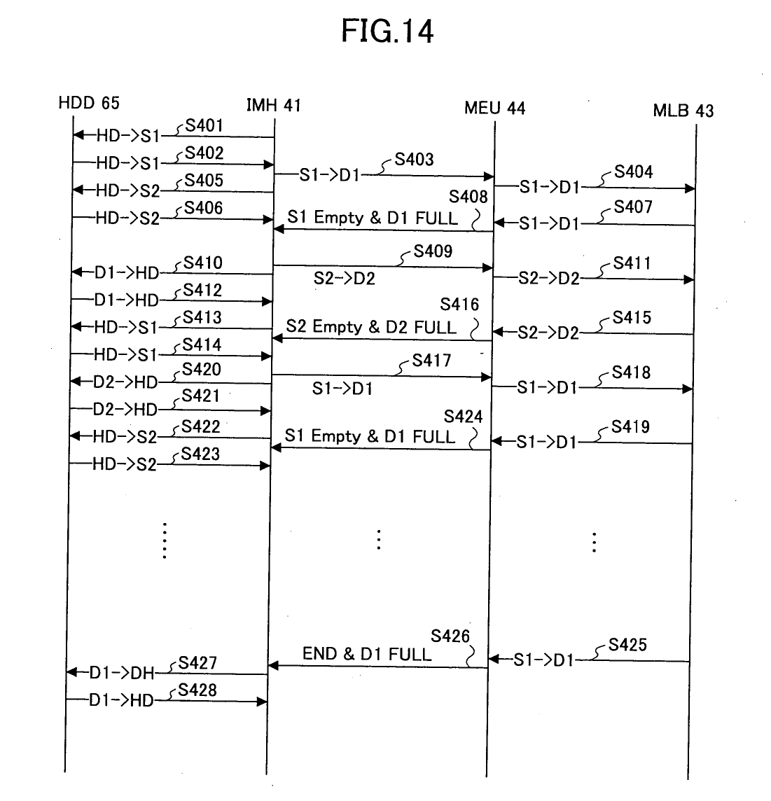

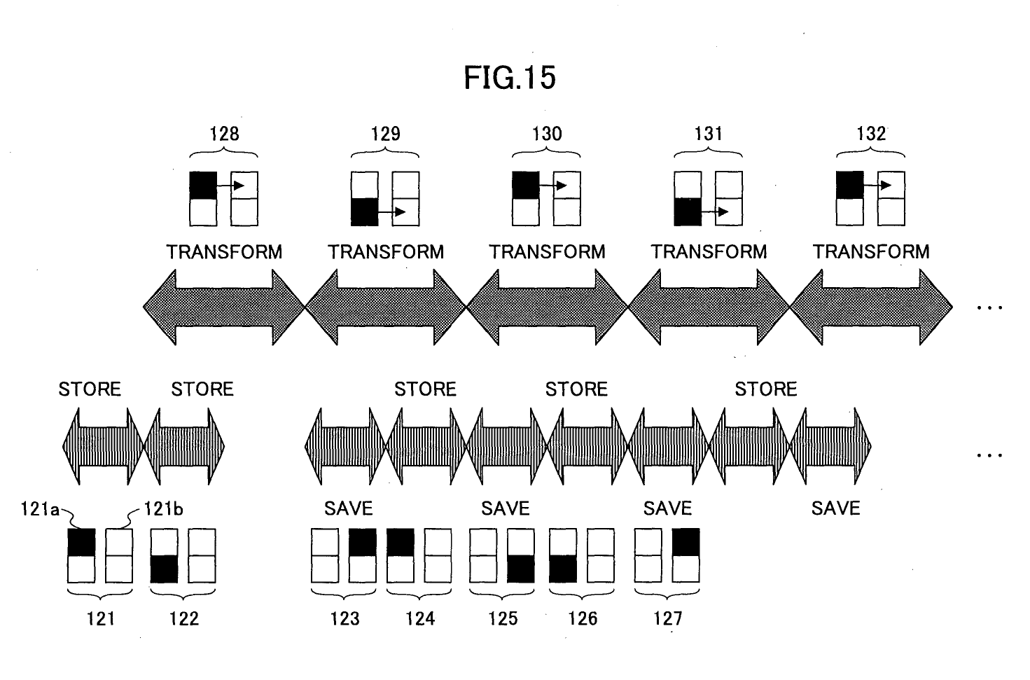

A description will be given of the processing of the first pattern with reference to FIG. 15 and FIG. 14.

In addition, in the sequence diagram of FIG. 14, “HD” indicates HDD 65, and S1, S2, D1 and D2 indicate the respective image data areas of FIG. 6. Moreover, in the image data areas of FIG. 15, the reference numerals 121-132 indicate the respective image data areas.

The image data area 121 is explained to the example for these image data areas. Reference numeral 121a indicates one of the two image data areas where the image data to be transformed is stored, and reference numeral 121b indicates one of the two image data areas where the transformed image data is stored. And the image data area where the image data was stored is expressed black, and the image data area which is not stored is expressed in white.

A description will be given of the sequence diagram of FIG. 14.

As shown in FIG. 14, IMH 41 stores the image data in the area S1 from HDD 65 at step S401 and step S402.

By this processing, the image data area turns into the image data area 121 of FIG. 15.

And it is required that IMH 41 should transform the image data stored in the area S1 to MEU 44, and should store it in the area D1 at step S403.

MEU 44 which received the request is step S404, and requires the transformation of the image data of MLB 43.

And MLB 43 transforms the image data of the area S1, and stores it in the area D1.

The image data area 128 of FIG. 15 expresses this processing.

While MLB 43 transforms the image data at this time, IMH 41 is step S405 and step S406, and stores the image data in the area S2.

By this processing, the image data area turns into the image data area 122 of FIG. 15.

Thus, if IMH 41 has the area in which the image data is not stored in other areas after storing the image data in the area, it stores the image data in the area further.

MLB 43 is step S407 and notifies to MEU 44 that the transformation of the image data of the area S1 is completed.

MEU 44 notifies that the transformation of the image data is completed to IMH 41 at step S408 by having received the notice which the transformation ended.

Since the image data of the area S1 is transformed at this time, the area S1 is vacant (empty), and the transformed image data is stored in the area D1 (full).

It is required that IMH 41 which received the notice of the transformation end should transform the image data which is step S409 and was stored in the area S2 to MEU 44, and should store it in the area D2.

MEU 44 which received the request is step S411, and requires the transformation of the image data stored in the area S2 from MLB 43.

And MLB 43 transforms the image data of the area S2, and stores it in the area D2.

The image data area 129 of FIG. 15 expresses this processing.

Moreover, while MLB 43 transforms the image data, IMH(s)41 are step S410 and step S412, and save the image data stored in the area D1 to HDD 65.

By this processing, the image data area turns into the image data area 123 of FIG. 15.

IMH 41 stores the image data in the area S1 from HDD 65 at step S413 and step S414 immediately after that.

By this processing, the image data area turns into the image data area 124 of FIG. 15.

After the transforming of MLB 43 performed in parallel with this processing is completed, MLB 43 is step S415 and notifies to MEU 44 that the transformation of the image data of the area S2 is completed.

MEU 44 notifies that the transformation is completed to IMH 41 at step S416 by having received the notice which the transformation ended.

Since the image data of the area S2 is transformed at this time, the area S2 is vacant (empty), and the transformed image data is stored in the area D2 (full).

Next, it is required that IMH 41 should transform the image data which is step S417 and was stored in the area S1 to MEU 44, and should store it in the area D1.

MEU 44 which received the request is step S418, and requires the transformation of the image data stored in the area S1 from MLB 43.

And MLB 43 transforms the image data of the area S1, and stores it in the area D1.

The image data area 130 of FIG. 15 expresses this processing.

It is parallel to this processing, and IMH 41 is step S416 like the point, since the notice of the transformation of the image data of the area S2 being completed was received, they are step S420 and step S421, and it saves the image data stored in the area D2 to HDD 65.

By this processing, the image data area turns into the image data area 125 of FIG. 15.

IMH 41 stores the image data in the area S2 from HDD 65 at step S422 and step S423 immediately after that.

By this processing, the image data area turns into the image data area 126 of FIG. 15.

Moreover, MLB 43 which the transformation of the image data of the area S1 ended is step S419, and notifies to MEU 44 that the transformation of the image data of the area S1 is completed.

MEU 44 notifies that the transformation is completed to IMH 41 at step S424 by having received the notice which the transformation ended.

Since the image data of the area S1 is transformed at this time, the area S1 is vacant (empty), and the transformed image data is stored in the area D1 (full).

Henceforth, the image data stored in the areas S1 and S2 as MLB 43 was shown in the image data areas 131 and 132 is transformed, as IMH 41 is shown in the image data area 127, it saves to HDD 65, or the image data is stored, and processing is continued.

And MLB 43 notifies to MEU 44 that the transformation of the image data of the area S1 is completed to MEU 44 at step S425.

By this notice, MEU 44 notifies that the transformation is completed to IMH 41 at step S426.

At step S426, if the end (END) of processing is notified from MEU 44, IMH 41 will save the image data stored in the area D1 to HDD 65 at step S427 and step S428, and will end processing.

Thus, while IMH 41 transforms the image data stored in the image data area, it is shown that MEU 44 stores in the image data area the image data transformed into the degree by MLB 43.

In order to retain the image data to be transformed, the two image data areas are provided to store the image data.

And IMH 41 stored the image data memorized by HDD 65 for every area, and transforms MLB 43 for every image data stored in the one area.

If IMH 41 has the area in which the image data is not stored in other areas after storing the image data in the area, it stores the image data in the area further.

While MLB 43 transforms the image data and stores in the image data area, it is also shown that IMH 41 saves the image data stored in the image data area to HDD 65.

In order to retain the transformed image data, the two image data areas are provided to store the transformed image data.

And MLB 43 stored the transformed image data for every area, and IMH 41 saves it to HDD 65 for every image data stored in the one area.

Next, a description will be given of the case of the second pattern.

The second pattern is contrary to the first pattern, and it is the case where the transforming time of MLB 43 is smaller than the time which added time to save time to store the image data and the image data.

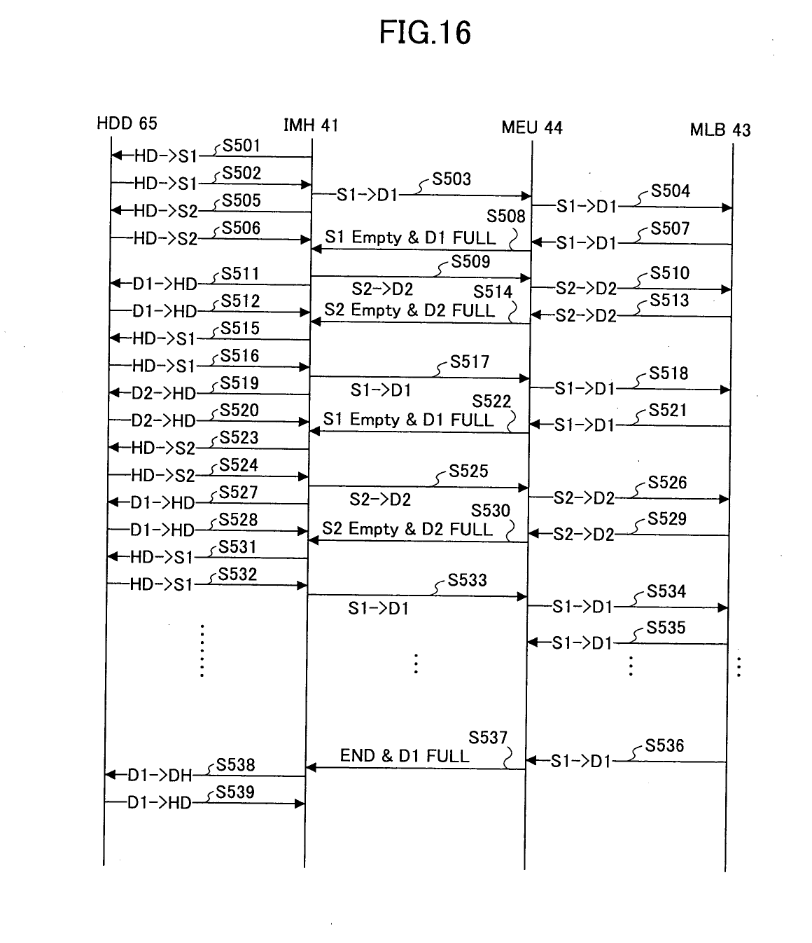

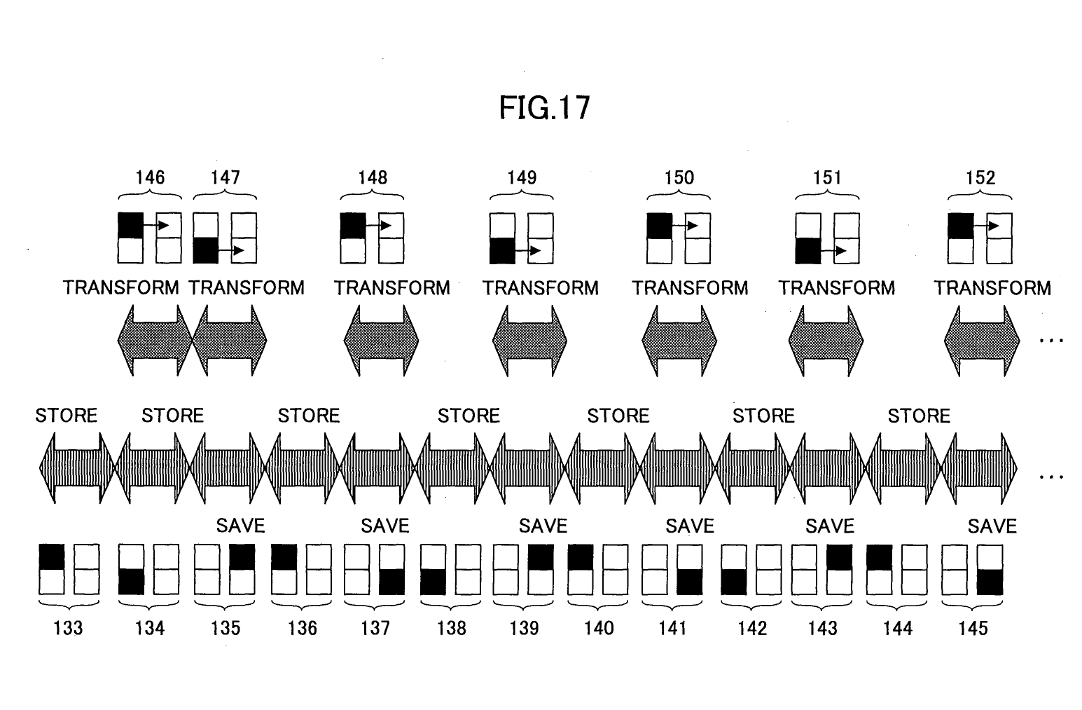

A description will be given of the processing of the second pattern with reference to FIG. 16 and FIG. 17.

As shown in FIG. 16, IMH 41 first stores the image data in the area S1 from HDD 65 at step S501 and step S502.

By this processing, the image data area turns into the image data area 133 of FIG. 17.

And it is required that IMH 41 should transform the image data stored in the area S1 to MEU 44, and should store it in the area D1 at step S503.

MEU 44 which received the request is step S504, and requires the transformation of the image data of MLB 43.

And MLB 43 transforms the image data of the area S1, and stores it in the area D1.

The image data area 146 of FIG. 17 expresses this processing.

While MLB 43 transforms the image data at this time, IMH 41 is step S505 and step S506, and stores the image data in the area S2.

By this processing, the image data area turns into the image data area 134 of FIG. 17.

MLB 43 is step S507 and notifies to MEU 44 that the transformation of the image data of the area S1 is completed.

MEU 44 notifies that the transformation of the image data is completed to IMH 41 at step S508 by having received the notice which the transformation ended.

Since the image data of the area S1 is transformed at this time, the area S1 is vacant (empty), and the transformed image data is stored in the area D1 (full).

It is required that IMH 41 which received the notice of the transformation end should transform the image data which is step S509 and was stored in the area S2 to MEU 44, and should store it in the area D2.

MEU 44 which received the request is step S510, and requires the transformation of the image data stored in the area S2 from MLB 43.

And MLB 43 transforms the image data of the area S2, and stores it in the area D2.

The image data area 147 of FIG. 17 expresses this processing.

Moreover, while MLB 43 transforms the image data, IMH(s)41 are step S511 and step S512, and save the image data stored in the area D1 to HDD 65.

By this processing, the image data area turns into the image data area 135 of FIG. 17.

After the transforming of MLB 43 performed in parallel with this processing is completed, MLB 43 is step S513 and notifies to MEU 44 that the transformation of the image data of the area S2 is completed.

MEU 44 notifies that the transformation is completed to IMH 41 at step S514 by having received the notice which the transformation ended.

Since the image data of the area S2 is transformed at this time, the area S2 is vacant (empty), and the transformed image data is stored in the area D2 (full).

Next, IMH 41 stores the image data in the area S1 from HDD 65 at step S515 and step S516.

By this processing, the image data area turns into the image data area 136 of FIG. 17.

And it is required that IMH 41 should transform the image data which is step S517 and was stored in the area S1 to MEU 44, and should store it in the area D1.

MEU 44 which received the request is step S518, and requires the transformation of the image data stored in the area S1 from MLB 43.

And MLB 43 transforms the image data of the area S1, and stores it in the area D1.

The image data area 148 of FIG. 17 expresses this processing.

It is parallel to this processing, and IMH 41 is step S517 like the point, since the notice of the transformation of the image data of the area S2 being completed was received, they are step S519 and step S520, and it saves the image data stored in the area D2 to HDD 65.

By this processing, the image data area turns into the image data area 137 of FIG. 17.

Moreover, MLB 43 which the transformation of the image data of the area S1 ended is step S521, and notifies to MEU 44 that the transformation of the image data of the area S1 is completed.

MEU 44 notifies that the transformation is completed to IMH 41 at step S522 by having received the notice which the transformation ended.

Since the image data of the area S1 is transformed at this time, the area S1 is vacant (empty), and the transformed image data is stored in the area D1 (full).

Next, IMH 41 stores the image data in the area S2 from HDD 65 at step S523 and step S524.

By this processing, the image data area turns into the image data area 138 of FIG. 17.

And it is required that IMH 41 should transform the image data which is step S525 and was stored in the area S2 to MEU 44, and should store it in the area D2.

MEU 44 which received the request is step S526, and requires the transformation of the image data stored in the area S2 from MLB 43.

And MLB 43 transforms the image data of the area S2, and stores it in the area D2.

The image data area 149 of FIG. 17 expresses this processing.

It is parallel to this processing, and IMH 41 is step S522 like the point, since the notice of the transformation of the image data of the area S1 being completed was received, they are step S527 and step S528, and it saves the image data stored in the area D1 to HDD 65.

The image data area is equivalent to the image data area 139 of FIG. 17 with this processing.

Moreover, MLB 43 which the transformation of the image data of the area S2 ended is step S529, and notifies to MEU 44 that the transformation of the image data of the area S2 is completed.

MEU 44 notifies that the transformation is completed to IMH 41 at step S530 by having received the notice which the transformation ended.

Since the image data of the area S2 is transformed at this time, the area S1 is vacant (empty), and the transformed image data is stored in the area D2 (full).

Next, IMH 41 stores the image data in the area S1 from HDD 65 at step S531 and step S532.

By this processing, the image data area turns into the image data area 140 of FIG. 17.

And it is required that IMH 41 should transform the image data which is step S533 and was stored in the area S1 to MEU 44, and should store it in the area D1.

MEU 44 which received the request is step S534, and requires the transformation of the image data stored in the area S2 from MLB 43.

And MLB 43 transforms the image data of the area S1, and stores it in the area D1.

The image data area 150 of FIG. 17 expresses this processing.

MLB 43 which the transformation of the image data of the area S2 ended is step S535, and notifies to MEU 44 that the transformation of the image data of the area S1 is completed.

Henceforth, the image data stored in the areas S1 and S2 as MLB 43 was shown in the image data areas 151 and 152 is transformed, as IMH 41 is shown in the image data areas 141, 142, 143, 144, and 145, it saves to HDD 65, or the image data is stored, and processing is continued.

And MLB 43 notifies to MEU 44 that the transformation of the image data of the area S1 is completed to MEU 44 at step S536.

By this notice, MEU 44 notifies that the transformation is completed to IMH 41 at step S534.

At step S534, if the end (END) of processing is notified from MEU 44, IMH 41 will save the image data stored in the area D1 to HDD 65 at step S535 and step S536, and will end processing.

Next, a description will be given of the case of the third pattern.

In the case of the third pattern, the transforming time of MLB 43 is rather longer than in the case of the first pattern.

Suppose the case where the compressibility at the time of transforming the image data is high.

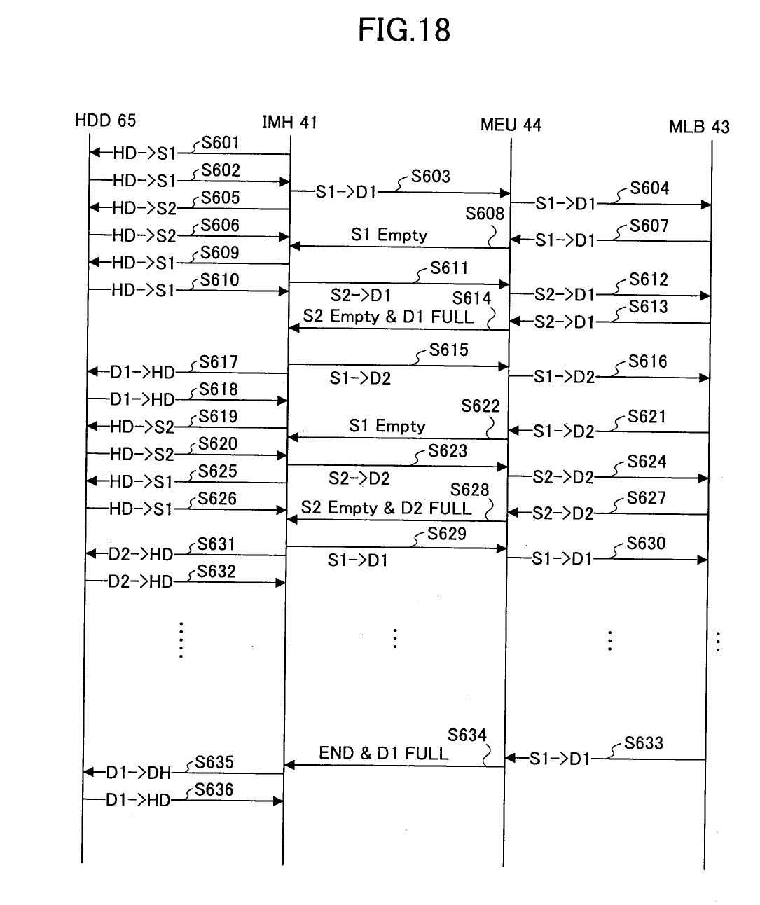

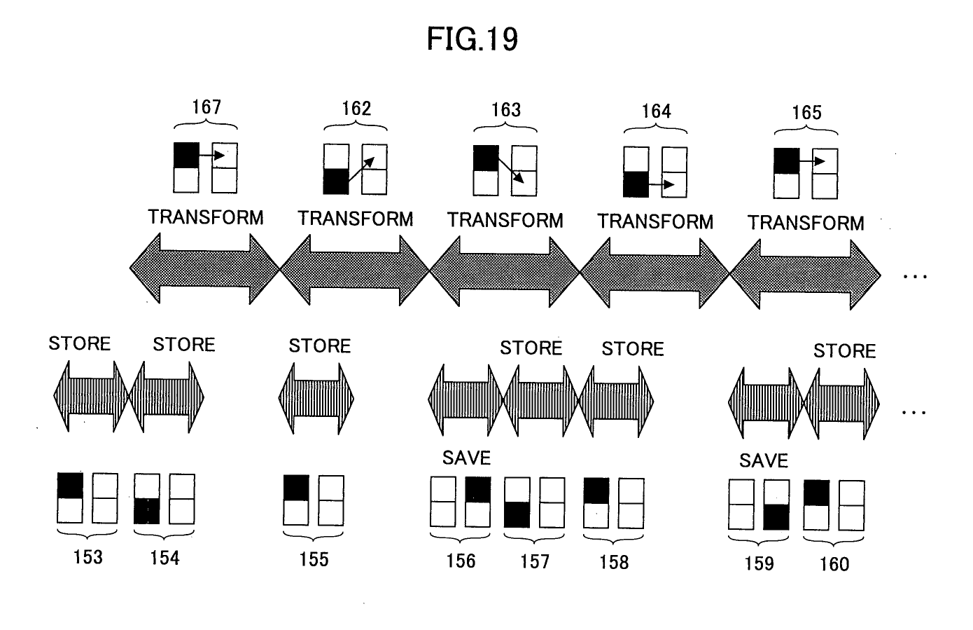

A description will be given of the processing of the third pattern with reference to FIG. 18 and FIG. 19.

As shown in FIG. 18, IMH 41 first stores the image data in the area S1 from HDD 65 at step S601 and step S602.

By this processing, the image data area turns into the image data area 153 of FIG. 19.

And it is required that IMH 41 should transform the image data stored in the area S1 to MEU 44, and should store it in the area D1 at step S603.

MEU 44 which received the request is step S604, and requires the transformation of the image data of MLB 43.

And MLB 43 transforms the image data of the area S1, and stores it in the area D1.

The image data area 167 of FIG. 19 expresses this processing.

While MLB 43 transforms the image data at this time, IMH 41 is step S605 and step S606, and stores the image data in the area S2.

By this processing, the image data area turns into the image data area 154 of FIG. 19.

MLB 43 is step S607 and notifies to MEU 44 that the transformation of the image data of the area S1 is completed.

MEU 44 notifies that the transformation of the image data is completed to IMH 41 at step S608 by having received the notice which the transformation ended.

Since the image data of the area S1 is transformed at this time, the area S1 is vacant (empty).

Moreover, although the transformed image data is stored in the area D1, when compressibility is high, the margin is in the area D1, and since it is possible to store the image data succeedingly, the image data transformed into the degree is stored following on the image data which the point stored.

In this case, it is assumed that storing the transformed image data in the one area to two is possible.

Next, while MLB 43 transforms the image data, IMH(s)41 are step S609 and step S610, and store the image data in the area S1 from HDD 65.

By this processing, the image data area turns into the image data area 155 of FIG. 19.

It is required that IMH 41 should transform the image data which is step S611 and was stored in the area S2 to MEU 44, and should store it in the area D1 with this processing.

Next, MEU 44 is step S612, the image data stored in the area S2 to MLB 43 is transformed, and it demands to store in the area D1.

And MLB 43 transforms the image data of the area S2, and stores it in the area D1.

The image data area 162 of FIG. 19 expresses this processing.

After the transforming of MLB 43 is completed, MLB 43 is step S613 and notifies to MEU 44 that the transformation of the image data of the area S2 is completed.

MEU 44 notifies that the transformation is completed to IMH 41 at step S614 by having received the notice which the transformation ended.

Since the image data of the area S2 is transformed at this time, the area S2 is vacant (empty), and the two transformed image data is stored in the area D1 (full).

Next, it is required that IMH 41 should transform the image data which is step S615 and was stored in the area S1 to MEU 44, and should store it in the area D2.

It is required that MEU 44 which received the request should transform the image data which is step S618 and was stored in the area S1 to MLB 43, and should store it in the area D2.

And MLB 43 transforms the image data of the area S1, and stores it in the area D1.

The image data area 163 of FIG. 19 expresses this processing.

It is parallel to this processing, and IMH 41 is step S614 like the point, since the notice of that the transformation of the image data of the area S2 is completed and the area D1 being full was received, they are step S617 and step S618, and it saves the image data stored in the area D1 to HDD 65.

By this processing, the image data area turns into the image data area 156 of FIG. 19.

IMH 41 stores the image data in the area S2 from HDD 65 at step S619 and step S620 immediately after that.

By this processing, the image data area turns into the image data area 157 of FIG. 19.

Moreover, MLB 43 which the transformation of the image data of the area S1 ended is step S621, and notifies to MEU 44 that the transformation of the image data of the area S1 is completed.

MEU 44 notifies that the transformation is completed to IMH 41 at step S622 by having received the notice which the transformation ended.

Since the image data of the area S1 is transformed at this time, the area S1 is vacant (empty).

It is required that IMH 41 should transform the image data which is step S623 and was stored in the area S2 to MEU 44, and should store it in the area D2.

MEU 44 which received the request is step S624, and requires the transformation of the image data stored in the area S2 from MLB 43.

And MLB 43 transforms the image data of the area S2, and stores it in the area D2.

The image data area 164 of FIG. 19 expresses this processing.

It is parallel to this processing and IMH 41 stores the image data in the area S1 from HDD 65 at step S625 and step S626.

By this processing, the image data area turns into the image data area 158 of FIG. 19.

MLB 43 which the transformation of the image data of the area S2 ended is step S627, and notifies to MEU 44 that the transformation of the image data of the area S2 is completed.

MEU 44 notifies that the transformation is completed to IMH 41 at step S628 by having received the notice which the transformation ended.

Since the image data of the area S2 is transformed at this time, the area S2 is vacant (empty), and the transformed image data is stored in the area D2 (full).

Next, it is required that IMH 41 should transform the image data which is step S629 and was stored in the area S1 to MEU 44, and should store it in the area D1.

MEU 44 which received the request is step S630, and requires the transformation of the image data stored in the area S1 from MLB 43.

And MLB 43 transforms the image data of the area S1, and stores it in the area D1.

The image data area 165 of FIG. 19 expresses this processing.

Moreover, while MLB 43 transforms the image data, IMH(s)41 are step S631 and step S632, and save the image data stored in the area D2 to HDD 65.

By this processing, the image data area turns into the image data area 159 of FIG. 19.

Henceforth, MLB 43 transforms the image data stored in the areas S1 and S2, as IMH 41 is shown in the image data area 166, the image data is stored in HDD 65, or it saves, and processing is continued.

And MLB 43 notifies to MEU 44 that the transformation of the image data of the area S2 is completed to MEU 44 at step S633.

By this notice, MEU 44 notifies that the transformation is completed to IMH 41 at step S634.

If the end (END) of processing is notified from MEU 44, IMH 41 will save the image data stored in the area D1 to HDD 65 at step S635 and step S636, and will end processing.

It is about the memory at the time of the above transforming the image data, and the operation of HDD.

Next, a description will be given of the 2nd processing. This processing is processing for using MLB 43 and the transform library 51 efficiently.

First, the details of the run thread 50 are explained.

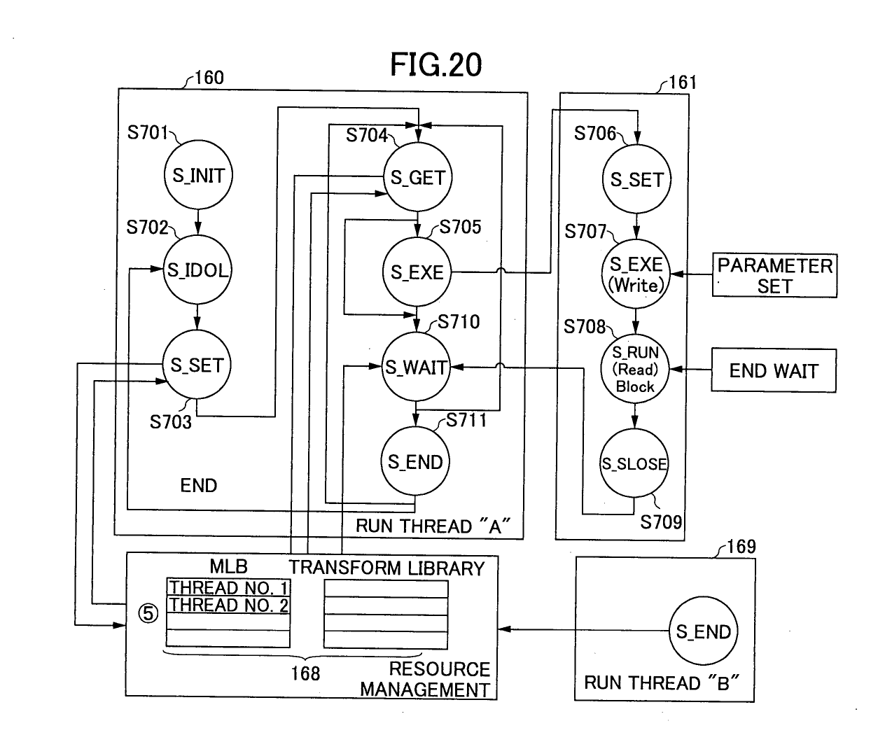

The state transition diagram 160 of the run thread A, the state transition diagram 169 of the run thread B from which the state serves as S_END and the state transition diagram 161 of the MLB control unit 47, and the queue 168 that the resource management unit 46 manages are shown in FIG. 20.

The state of the run thread A serves as S_INIT of step S701 which shows the state of performing initialization processing first.

This initialization processing is processing to which initialization of the variable to be used etc. is carried out, for example.

The state of the run thread A which completed initialization changes to S_IDOL of step S702.

The processing with this substantial S_IDOL is the state which nothing carries out.

If the transformation request is notified to the run thread A from IMH 41 as this state, the state will change to S_SET of step S703.

This state is the state for which processing which generates the task according to the request is performed.

At this time, it is asked using any of MLB 43 and the transform library 51 the run thread A is transformed to the resource management unit 46.

And the resource management unit 46 chooses either by the selection method mentioned later, and returns the selection result to the run thread A.

Next, the state of the run thread A is step S704, and serves as S_GET which is the state which acquires the resource which is selected by the resource management unit 46.

Thus, if the state becomes S_GET, the following state will be whether the resource required for the task was acquirable, and will be divided into two.

First, the case where the resource is acquirable is explained.

In state S_GET, the run thread A gives the resource acquisition demand to the resource management unit 46, it is the resource acquisition response, and when the resource is able to be acquired, the state changes to S_EXE of step S705, and the run thread A performs the image data transformation request to the MLB control unit 47.

Thereby, the state changes to S_WAIT of step S710.

This state is the state which waits for the response from the MLB control unit 47.

And if there is the response from the MLB control unit 47, the state changes to S_EXE of step S705 again, when the transforming is continued, and when there is no necessity for continuation, it will change to S_END of step S711.

If the state changes to S_END, it will determine whether the run thread A ends the task or performs the following task.

When ending the task, since processing is completed, the state changes to S_IDOL of step S702.

When performing the following task, the state changes to S_GET again.

When the above is state S_GET, they are changes of the state when the resource is acquirable.

When the resource is not able to be acquired at the time of state S_GET, the state does not change to S_EXE but changes to S_WAIT.

Moreover, the image data is managed by the resource acquisition request at that time at the queue 168 which manages the turn that the resource management unit 46 transforms the image data.

The queue 168 is provided for each of the transform library 51 and MLB 43.

Moreover, the turn of the image data in the queue 168 is managed by ID of the run thread A which has notified the resource acquisition request.

In order that this may transform only the one image data per run thread, if ID of the run thread A is stacked, it will come out enough as the information and a certain thing will be the reason.

The run thread A is the state of S_WAIT, and it waits for it until the resource becomes acquirable.

And an end of processing of the run thread B notifies having released the resource to the resource management unit 46.

If it is notified that the resource became acquirable from the resource management unit 46, the state will change to S_EXE of step S705.

Changes of the state after this become the same as changes of the state when the resource is acquirable.

Next, the state transition diagram 161 of the MLB control unit 47 is explained.

By the request from the run thread A, the state of the MLB control unit 47 serves as S_SET of step S706 which is the state which generates the task.

Next, the state of the MLB control unit 47 serves as S_EXE of step S707, and the MLB control unit 47 sets the parameter to the register of MLB 43, in order to transform the image data.

Thereby, the state changes to S_RUN of step S708 which shows under execution of processing.

After the transforming of MLB 43 is completed, the state of the MLB control unit 47 serves as S_CLOSE of step S709 which shows the end of the transforming.

And at this time, the MLB control unit 47 notifies the end of the transformation to the run thread A, and ends processing.

Next, the processing in the state changes explained above is explained using the flowchart.

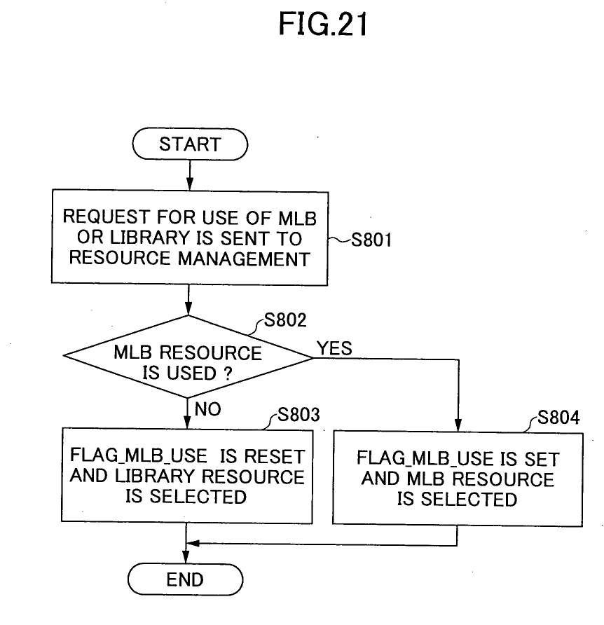

FIG. 21 is a flowchart for explaining the processing in the run thread 50 from state S_SET to S_GET.

The run thread 50 asks the resource management unit 46 at step S801, using which of MLB 43 or the transform library 51.

Thus, in case the run thread 50 transforms the image data, it notifies the selection request as which it makes it choose it any to be used between MLB 43 and the transform library 51 to the resource management unit 46.

Next, when the selection result notified from resource management is MLB 43, the run thread 50 substitutes for step S802 SET which shows that MLB 43 is used for FLAG_MLB_USE which is the flag used by the processing in the run thread 50 at step S804.

When this is compared by C, it is substituting SET by which the value's was defined as FLAG_MLB_USE which is the variable by #define of the preprocessor.

RESET which shows that MLB 43 is not used for FLAG_MLB_USE which is the flag for which the selection result notified from resource management uses the run thread 50 by processing in the run thread 50 at step S803 in the case of the transform library 51 is substituted.

After these processings are completed, the state of the run thread 50 changes to S_GET.

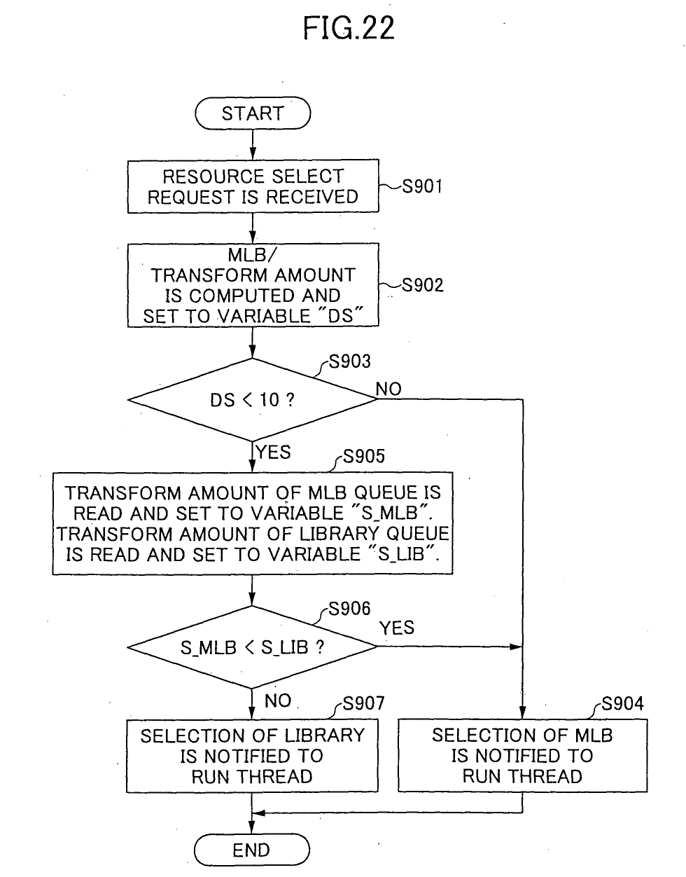

Next, a description will be given of the processing performed by the resource management unit 46 with reference to FIG. 22.

In the flowchart of FIG. 22, at step S901, the resource selection request is notified to the resource management unit 46 from the run thread 50.

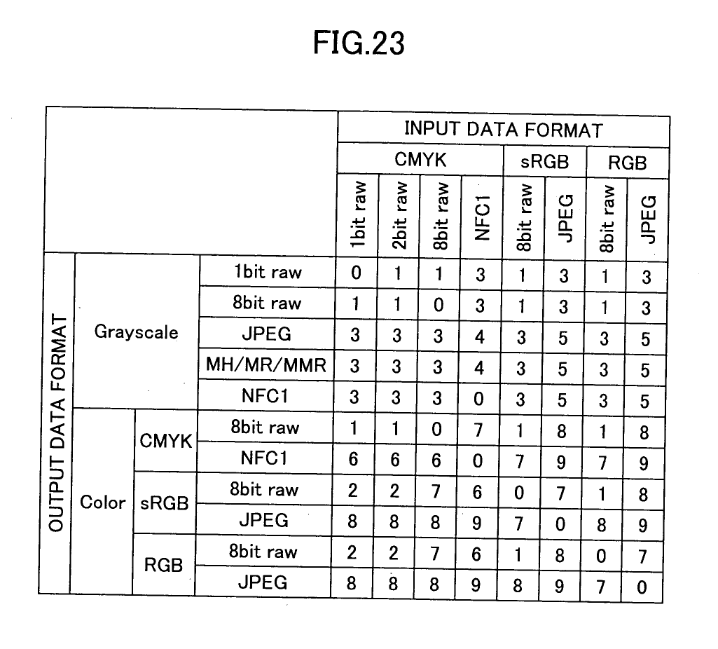

At step S902, the resource management unit 46 computes the transform amount of the image data so that the resource management unit 46 may choose MLB 43 or the transform library 51 for the transforming process. The processing of step S902 will now be explained with reference to FIG. 23.

FIG. 23 shows a table which is used in order that the resource management unit 46 may choose MLB 43 or the transform library 51.

The table is used to calculate the transform amount from the data format of the image data before the transforming and the data format of the image data after the transforming. In addition, this table may be included in the program beforehand using the array etc., HDD 65 which is the nonvolatile storage apparatus is used to retain the table, and it is possible that the table be read from HDD 65 by the program.

As shown in FIG. 23, the items arrayed in the column direction of the table indicate the input data format which is the format of the image data before transformation, and the items arrayed in the row direction of the table indicate the output data format which is the format of the image data after transformation.

The input data format of the table contains the three kinds of data format: “CMYK”, “sRGB”, and “RGB”. Among these, “CMYK” further contains the four kinds of data format: 1 bit raw, 2bit raw, 8 bit raw, and NFC1. Moreover, each of “sRGB” and “RGB” contains the two kinds of data format: 8 bit raw and JPEG.

The output data format of the table contains the two kinds of data format: “Grayscale” and “Color”. Among these, “Grayscale” further includes the five kinds of data format: 1 bit raw, 8 bit raw, JPEG, MH/MR/MMR, and NFC1. Moreover, “Color” further includes the three kinds of data format: “CMYK”, “sRGB”, and “RGB”. Furthermore, the “Color CMYK” contains the two kinds of data format: 8 bit raw and NFC1, and each of the “Color sRGB” and the “Color RGB” contains the two kinds of data format: 8 bit raw and JPEG.

For example, in a case in which the input data format is 8 bit raw of CMYK and the output data format is JPEG of Color RGB, the factor for use in the computation of the transform amount is set to 8 which is the number contained in the small box of the table where the corresponding column and the corresponding row of the table are intersected.

In another case in which the input data format is 8 bit raw of sRGB and the output data format is 8 bit raw of sRGB, there is no need to transform the image data, and the factor is set to 0.

Next, in order to compute the transform amount, the resource management unit 46 computes the product of the above-mentioned factor and the size of the image data to be transformed.

For example, if the factor is 8 and the size of the image data is 4 MB, then the product of the factor and the data size is set to 32. Moreover, if the factor is 6 and the size of the image data is 0.5 MB, then the product is set to 3. Furthermore, if the factor is 0 and the size of the image data is 4 MB, then the product is set to 0.

Thus, the resource management unit 46 calculates the transform amount of the image data based on the size of the image data to be transformed and the data formats of the image data before and after transformation, and chooses MLB 43 or the transform library 51 based on the calculated transform amount.

Referring back to FIG. 22, the resource management unit 46 at step S902 performs the above-described calculation and sets the calculated transform amount which is obtained by the above-mentioned calculation, to the variable “DS”.

At step S903, the resource management unit 46 determines whether the value of DS is smaller than 10. When the result of the determination of step S903 is negative (DS>10), it advances processing to step S904.

At step S904, to the demanded run thread 50, the resource management unit 46 notifies that MLB 43 is chosen, and ends processing.

On the other hand, when the result of the determination of step S903 is affirmative (DS<10), the resource management unit 46 advances processing to step S905.

At step S905, the resource management unit 46 reads the transform amount of all the image data in the queue of MLB 43 and sets the read transform amount to the variable S_MLB, and reads the transform amount of all the image data in the queue of the transform library 51 and sets the read transform amount to the variable S_LIB.

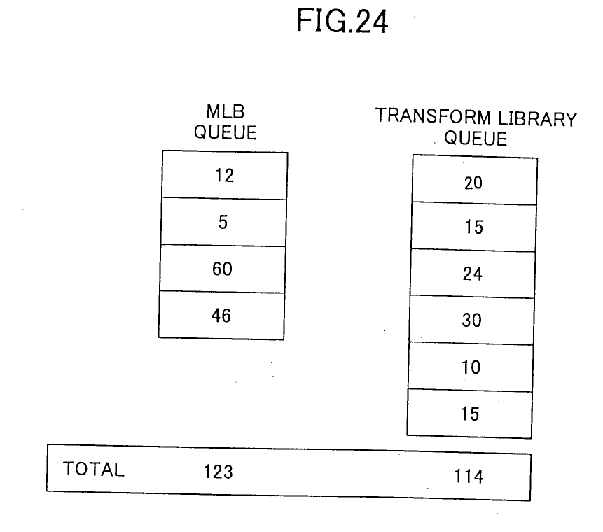

This processing will be described concretely with reference to FIG. 24. FIG. 24 shows the total of the transform amounts of the image data in the queue of MLB 43, and the total of the transform amounts of the image data in the queue of the transform library 51.

In the example of FIG. 24, the four image data are in the queue of the MLB 43, and the respective transform amounts of the image data are 12, 5, 60, and 46. Moreover, in the queue of the transform library 51, the six image data are stacked, and the respective transform amounts of the image data are 20, 15, 24, 30, 10, and 15. Hence, the total of the transform amounts of all the image data in the queue of MLB 43 is 123, and the total of the transform amounts of all the image data in the queue of the transform library 51 is 114.

For the above example, the resource management unit 46 at step S905 reads these values of 123 and 114, and sets the values to the variables S_MLB abd S_LIB respectively.

Thus, the resource management unit 46 chooses one of MLB 43 and the transform library 51 based on the transform amounts of the image data already stacked in the queues of MLB 43 and the transform library 51.

At this time, the resource management unit 46 substitutes the total transform amount of the queue of MLB 43 for the variable S_MLB, and substitutes the total transform amount of the queue of the transform library 51 for the variable S_LIB.

At step S906, the resource management unit 46 compares S_MLB with S_LIB.

When S_LIB is larger than S_MLB, the resource management unit 46 advances processing to step S904, and to the demanded run thread 50, notifies at step S904 that MLB 43 is chosen. Then, the resource management unit 46 ends processing.

On the other hand, when it is determined at step S906 that S_LIB is smaller than S_MLB, the resource management unit 46 advances processing to step S907, and to the demanded run thread 50, notifies at step S907 that the transform library 51 is chosen. Then, the resource management unit 46 ends processing.

Thus, the resource management unit 46 chooses either MLB 43 or the transform library 51 based on the transform amount of the image data to be transformed.

And when the resource selection request is notified to the resource management unit 46 from the run thread 50, the resource management unit 46 notifies the selection result to the run thread 50.

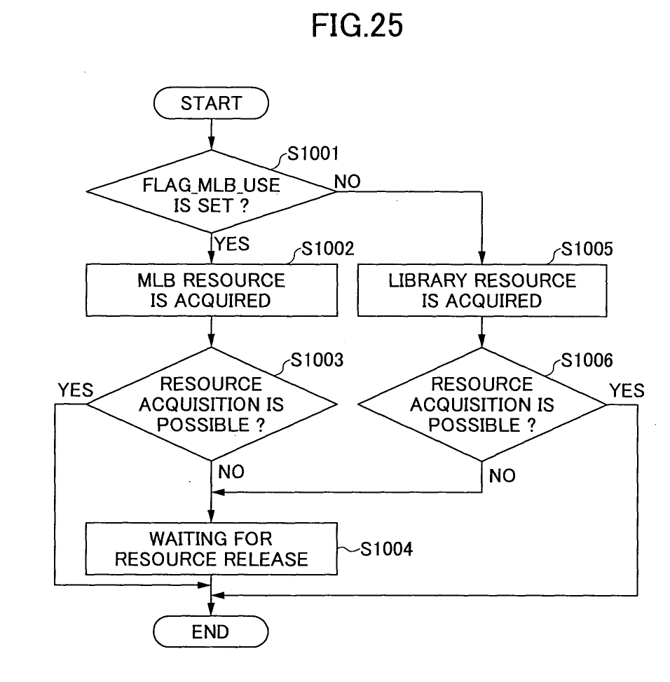

Next, a description will be given of the processing when the state of the run thread 50 is S_GET, with reference to FIG. 25.

The run thread 50 at step S1001 branches processing with the value of FLAG_MLB_USE which is previously substituted for.

When FLAG_MLB_USE is set, the run thread 50 notifies the resource acquisition request to the resource management unit 46 at step S1002, in order to acquire the resource of MLB 43.

At step S1003, the run thread 50 ends the processing in state S_GET, when the resource is able to be acquired by the notice from the resource management unit 46.

Moreover, at step S1003, when the resource is not able to be acquired, the run thread 50 changes the state to S_WAIT, and serves as release waiting of the resource.

It returns to processing of step S1001, and when FLAG_MLB_USE is reset, the run thread 50 notifies the resource acquisition request to the resource management unit 46 at step S1005, in order to acquire the resource of the transform library 51.

At step S1006, the run thread 50 ends the processing in state S_GET, when the resource is able to be acquired by the notice from the resource management unit 46.

Moreover, at step S1006, when the resource is not able to be acquired, the run thread 50 is step S1004, changes the state to S_WAIT and serves as release waiting of the resource.

Thus, if the selection result is notified to the run thread 50, it will notify the resource acquisition request which acquires the resource of selected MLB 43 or the transform library 51 to the resource management unit 46.

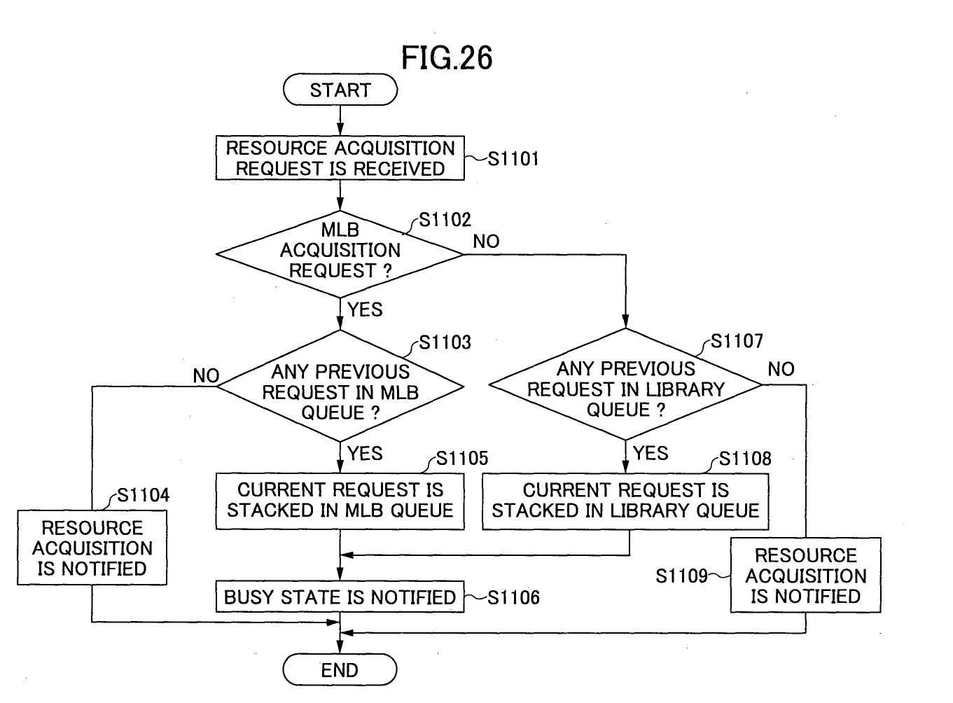

Next, a description will be given of the processing performed by the resource management unit 46, with reference to FIG. 26.

At step S1101, the resource acquisition request is notified to the resource management unit 46 from the run thread 50.

At step S1102, the resource management unit 46 determines whether it is the resource acquisition request to MLB 43.

In the resource acquisition request to MLB 43, the resource management unit 46 at step S1103 determines whether waiting is in the queue of MLB 43.

When there is no waiting, the resource management unit 46 is step S1104, notifies that the resource was acquirable to the run thread 50, and ends processing.

Thus, the resource management unit 46 will notify that the resource can be acquired to the run thread 50, if the demanded resource is acquirable.

When it is determined at step S1103 that waiting is in the queue of MLB 43, the ID of the run thread which has requested the queue of MLB 43 to the resource management unit 46 is added to the queue at step S1105.

And the resource management unit 46 at step S1106 notifies that it is in the BUSY state to the run thread 50, and ends processing.

Thus, the resource management unit 46 manages at the queue the turn of the image data which the run thread 50 transforms, when the demanded resource cannot be acquired.

It returns to processing of step S1102, and at step S1102, in the request of as opposed to the transform library 51 in the resource acquisition request, the resource management unit 46 is step S1107, and it determines whether waiting is in the queue of the transform library 51.

When there is no waiting, the resource management unit 46 is step S1109, notifies that the resource was acquirable to the run thread 50, and ends processing.

At step S1107, when waiting is in the queue of the transform library 51, the resource management unit 46 is step S1108, and stacks ID of the run thread required of the queue of the transform library 51.

And the resource management unit 46 is step S1106, there is no opening in the resource, notifies that it is in the BUSY state to the run thread 50, and ends processing.

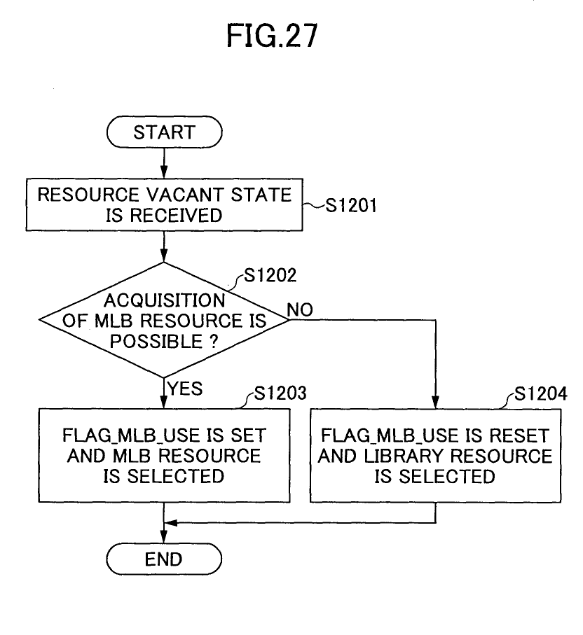

Next, a description will be given of the processing of the run thread 60 when the resource can be acquired from the state of S_WAIT (the state of resource acquisition waiting) and the state changes to the state of S_GET, with reference to FIG. 27.

At step S1201, the run thread 50 receives the state that the resource is vacant from the resource management unit 46.

At step S1202, the run thread 50 determines whether the acquisition of the resource of MLB 43 is possible. When the result of the determination of step S1202 is affirmative, the run thread 50 at step S1203 sets the flag FLAG_MLB_USE, which indicates the resource of MLB 43 is acquirable and is used in the processing of MLB 43. The run thread 50 selects the resource of MLB 43. Then, the run thread 50 ends the processing in the state of S_WAIT.

On the other hand, when the result of the determination of step S1202 is negative, the run thread 50 at step S1204 resets the flag FLAG_MLB_USE, which indicates that the resource of the transform library 51 is used. The run thread 50 selects the resource of the transform library 51. Then, the run thread 50 ends the processing in the state of S_WAIT.

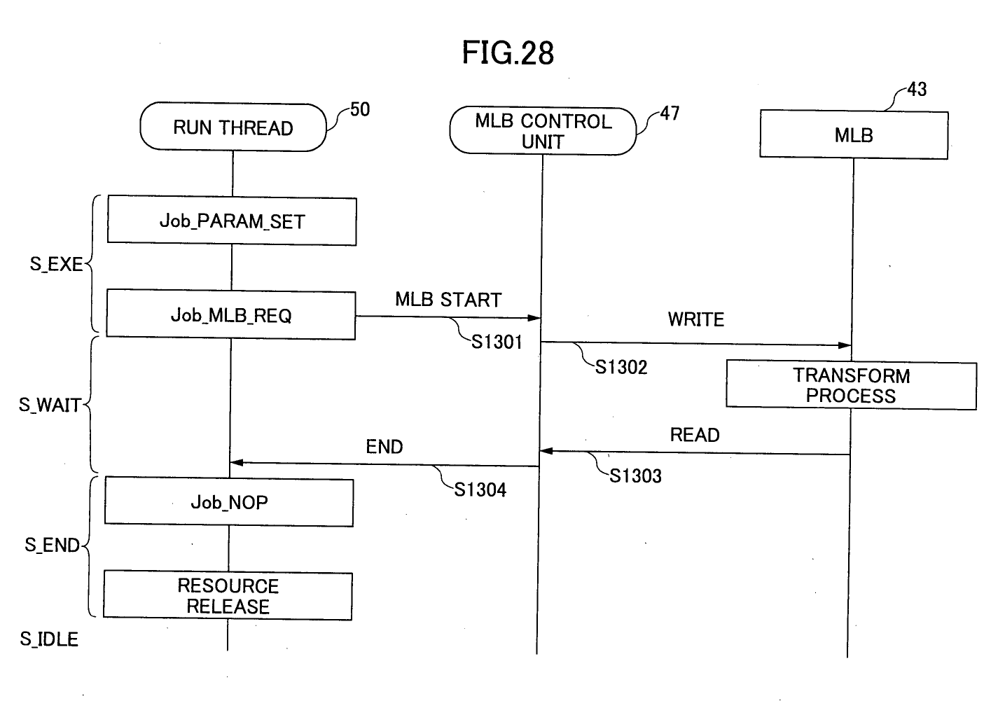

The above-described processing is now explained using the task which is generated by the run thread 50, with reference to FIG. 28.

With reference to FIG. 28, the processing in the case of using MLB 43 is explained.

FIG. 28 is a sequence diagram for explaining the processing performed by the run thread 50, the MLB control unit 47 and MLB 43 when the MLB 43 is used.

Moreover, the state of the run thread 50 and the contents of the task are also shown in FIG. 28.

In the sequence diagram of FIG. 28, the processing of the run thread 50, the MLB control unit 47 and the MLB 43 is shown, starting from the state in which the resource of MLB 43 is usable, the transforming process is performed, and the state of the run thread 50 changes from S_EXE to S_END.

If the state becomes S_EXE, Job_PARAM_SET of the task which the run thread 50 generated will operate.

This is processing which sets the parameter required in order to process by MLB 43.

After the set of the parameter is completed next, Job_MLB_REQ operates and the MLB start is notified at step S1301 to the MLB control unit 47.

Although this notice is performed by mail, other exchanges between the run thread 50 and the MLB control unit 47 are performed by mail.

Thus, the run thread 50 will notify the MLB start which is the image data transformation request for transforming the image data to the MLB control unit 47, if the resource of MLB 43 becomes usable.

If the MLB start is notified, since the state of the run thread 50 will be in the waiting state until the transforming of MLB 43 is completed, it will serve as S_WAIT.

To MLB 43, the MLB control unit 47 to which the MLB start is notified is step S1302, transforms the image data and notifies the writing which is the request written in the predetermined position.

Thereby, MLB 43 performs the transforming of the image data.

MLB 43 notifies the reading which shows that the transforming is completed to the MLB control unit 47 at step S1303, after the transforming is completed.

The MLB control unit 47 to which the reading is notified is step S1304, and notifies the end to the run thread 50.

Thus, the MLB control unit 47 to which the MLB start which is the image data transformation request is notified transforms the image data to MLB 43.

Moreover, the MLB control unit 47 notifies that the transformation is completed to the run thread 48 to which MLB 43 notified the image data transformation request after the transformation of the image data was completed.

Since the waiting state is canceled, the state of the run thread 50 to which the end was notified changes from S_WAIT to S_END.

Processing of the task is ended as shown in Job_NOP which shows task termination by this.

And the run thread 50 releases the resource of MLB.

Since a series of transformings by the above are ended, the state of the run thread 50 changes to S IDLE.

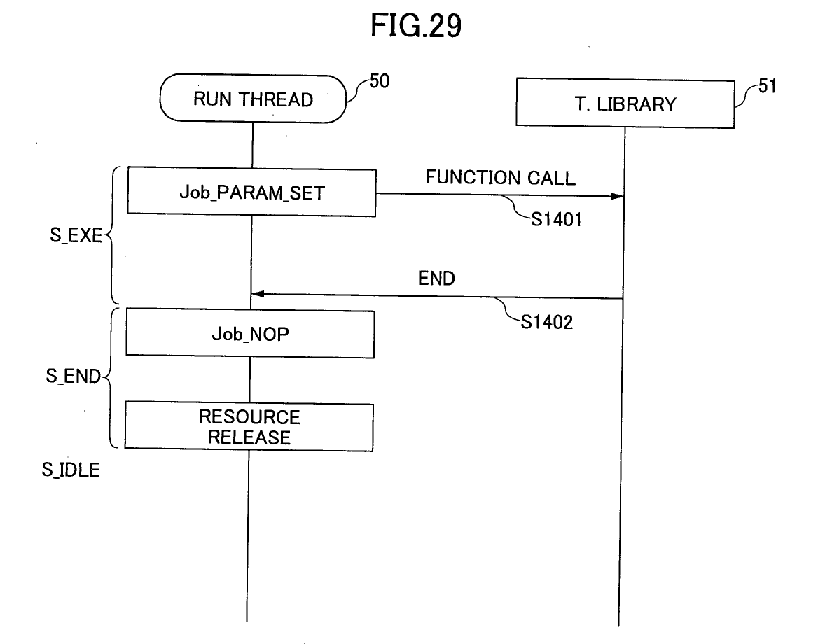

Next, a description will be given of the processing in the case of using the transform library 51, with reference to FIG. 29.

FIG. 29 is a sequence diagram between the run thread 50 and the transform library 51 when the transform library 51 is used.

Moreover, the state of the run thread 50 and the contents of the task are also shown in FIG. 29.

In the sequence diagram of FIG. 29, the processing of the run thread 50 and the transform library 51 is shown, starting from the state in which the resource of the transform library 51 is usable, the transforming process is performed, until the state of the run thread 50 changes from S_EXE to S_END.

If the state becomes S_EXE, Job_PARAM_SET of the task which is generated by the run thread 50 will operate.

This is processing which sets the parameter required in order to process in the transform library 51.

After the set of the parameter is completed, the run thread 50 is step S1401, and carries out the function call of the transform library 51.

And when the transforming is completed at step S1402, the state of the run thread 50 changes to S_END.

As shown in this processing, since the transform library 51 is not the thread, it can perform the transforming, without using mail.

In the function call, the program counter jumps to the address which has the function from the address of the program which calls the function, and the transforming is performed as it is.

And an end of processing of the function performs processing from the next address of the address which jumped the point.

That is, the transforming is substantially performed as processing of the run thread.

Moreover, if the function is made into the inline function of C in order to accelerate the processing in the function further, since the code of the function will be embedded directly in the place which called the function, although the program size becomes large, it becomes accelerable.

Even if this defines the function by the preprocessor mentioned above, it is possible.

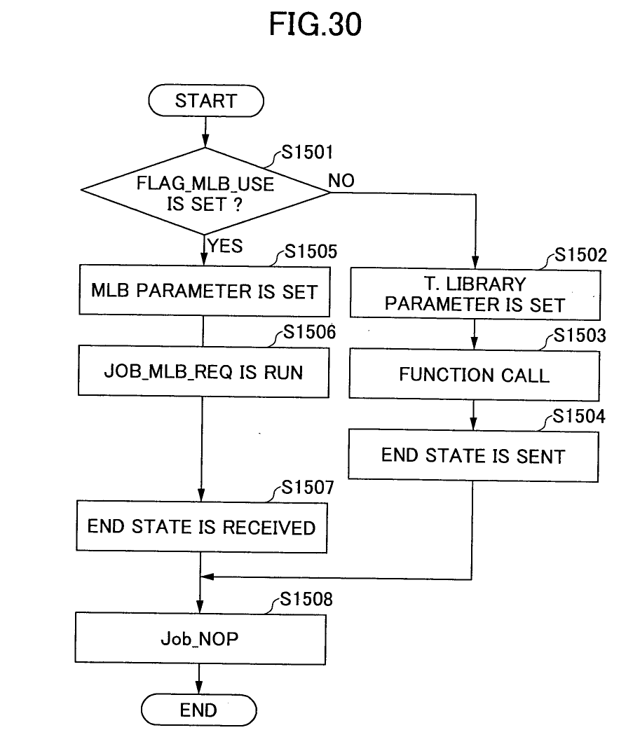

Next, a description will be given of the processing in the above-mentioned sequence diagram, with reference to the flowchart of FIG. 30.

At step S1501, the run thread 50 branches processing based on the flag FLAG_MLB_USE.

When transforming in the transform library 51, the parameter of the transform library 51 is set up at step S1502.

And the function call is performed at step S1503, the transformation is completed at step S1504, and the run thread 50 ends processing by Job_NOP of step S1508.

When transforming by MLB 43 at step S1501, the run thread 50 sets up the parameter of MLB 43 at step S1505.

And to the MLB control unit 47, the run thread 50 is step S1506, performs Job_MLB_REQ and receives the end from the MLB control unit 47 at step S1507.

The run thread 50 ends processing by Job_NOP of step S1508.

The above is processing for using MLB 43 and the transform library 51 efficiently.

Next, a description will be given of the third processing, which relates to the management method of the queue mentioned above.

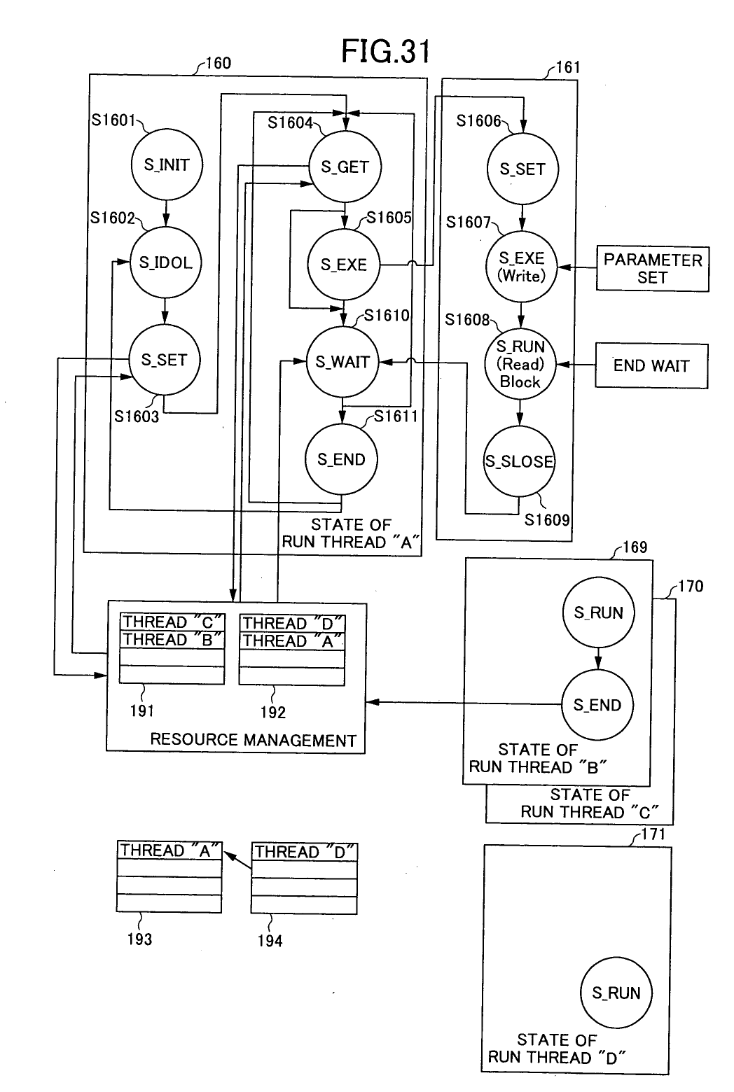

First, the management method of the queue will be described with reference to FIG. 31.

FIG. 31 shows the state transition diagram 160 of the run thread A, the state transition diagram 169 of the run thread B, the state 171 of the run thread D, the state 170 of the run thread C that has ended processing, the state transition diagram 161 of the MLB control unit 47 and the queues 191 and 193 of MLB 43 which are managed by the resource management unit 46, and the queues 192 and 194 of the transform library 51.

Thus, the resource management unit 46 has the queue for each of MLB 43 and transform library 51.

In addition, the queues 193 and 194 express the queue after the transforming which the threads C and B required from the state of the queues 191 and 192.

Next, the outline of the processing performed in FIG. 31 is explained.

The image data which Thread A transforms is managed at first at the queue of the transform library 51, as shown in the queue 192.

And since processing of MLB 43 which is hardware is quick when MLB 43 and the transform library 51 start the transforming, the transformation of the image data which the run thread C managed by the queue 191 and the run thread B required is completed.

Then, as shown in the queue 194 and the queue 193, the resource management unit 46 locates for it in a line and changes the ranking of the image data which Thread A transforms into the queue 191 which becomes vacant.

Next, the details of the above-mentioned processing are explained.

The state of the run thread A serves as S_INIT of step S1601 which shows the state of performing initialization processing first.

For example, this initialization processing is processing to which initialization of the variable to be used etc. is carried out.

The state of the run thread A which completed initialization changes to S_IDOL of step S1602.

The processing with this substantial S_IDOL is the state in which nothing is carried out.

If the transformation request is notified to the run thread A from IMH 41 as this state, the state will change to S_SET of step S1603.

This state is the state for which processing which generates the task according to the request is performed.

At this time, it is requested that using any of MLB 43 and the transform library 51 the run thread A is transformed to the resource management unit,46.

And the resource management unit 46 chooses either by the selection method mentioned later, and returns the selection result to the run thread A.

In this case, the image data which is transformed by the thread A is transformed with the transform library 51 chosen, and the queue 92 of the transform library 51 is chosen.

Next, the state of the run thread A, at step S1604, changes to S_GET which is the state in which the resource previously selected by the resource management unit 46 is acquired.

Thus, when the state becomes S_GET, the following state is one of two different states depending on whether the resource required for the task is acquirable.

In this case, only the description of the queue is given, and it is supposed that the resource is unacquirable.

In state S_GET, the run thread A gives the resource acquisition demand to the resource management unit 46, it is the resource acquisition response, and it is notified that it is unacquirable.

Moreover, the image data which Thread A transforms is managed by the queue 192 by the resource acquisition request at this time.

Thus, when the resource is not able to be acquired at the time of state S_GET, the state does not change to S_EXE of step S1605, but changes to S_WAIT of step S1610.

Moreover, the turn of the image data in the queues 191 and 192 is managed by ID of the run thread A which has notified the resource acquisition request.

In order that it may transform only the one image data per run thread, this is enough as the information, if ID of the run thread A is stacked.

The run thread A is the state of S_WAIT, and it waits for it until the resource becomes acquirable.

Then, the transformation of the image data of Thread C is completed, and the transformation of the image data of the thread B which is the following image data is performed, and it ends.

It notifies that the thread B which the transformation of the image data ended released the resource of MLB 43 to the resource management unit 46.

At this time, the resource management unit 46 locates for it in a line and changes the ranking of the image data which Thread A transforms into the queue 191 which became the empty, as mentioned above.

Since the resource which transforms the image data of Thread A was acquirable by this, if it is notified that the resource became acquirable from the resource management unit 46, the state of Thread A will change to S_EXE of step S1605.

If the run thread A changes to S_EXE of step S1605, it will perform the image data transformation request to the MLB control unit 47.

Thereby, the state changes to S_WAIT of step S1610.

This state is the state which waits for the response from the MLB control unit 47.

And if there is the response from the MLB control unit 47, the state changes to S_EXE of step S1605 again, when the transforming is continued, and when there is no necessity for continuation, it will change to S_END of step S1611.

If the state changes to S_END, it will determine whether the run thread A ends the task or performs the following task.

When ending the task, since processing is completed, the state changes to S_IDOL of step S1602.

When performing the following task, the state changes to S_GET of step S1604 again.

Next, a description will be given of the state transition diagram 161 of the MLB control unit 47.

By the request from the run thread A, the state of the MLB control unit 47 serves as S_SET of step S1606 which is the state which generates the task.

Next, the state of the MLB control unit 47 serves as S_EXE of step S1607, and the MLB control unit 47 sets the parameter to the register of MLB 43, in order to transform the image data.

Thereby, the state changes to S_RUN of step S1608 which shows under execution of processing.

After the transforming of MLB 43 is completed, the state of the MLB control unit 47 serves as S_CLOSE of step S1609 which shows the end of the transforming.

And at this time, the MLB control unit 47 notifies the end of the transformation to the run thread A, and ends processing.

Thus, the resource management unit 46 will notify that the resource can be acquired to the run thread A which required the acquisition of the resource based on the turn managed by the queue, if the resource becomes usable.

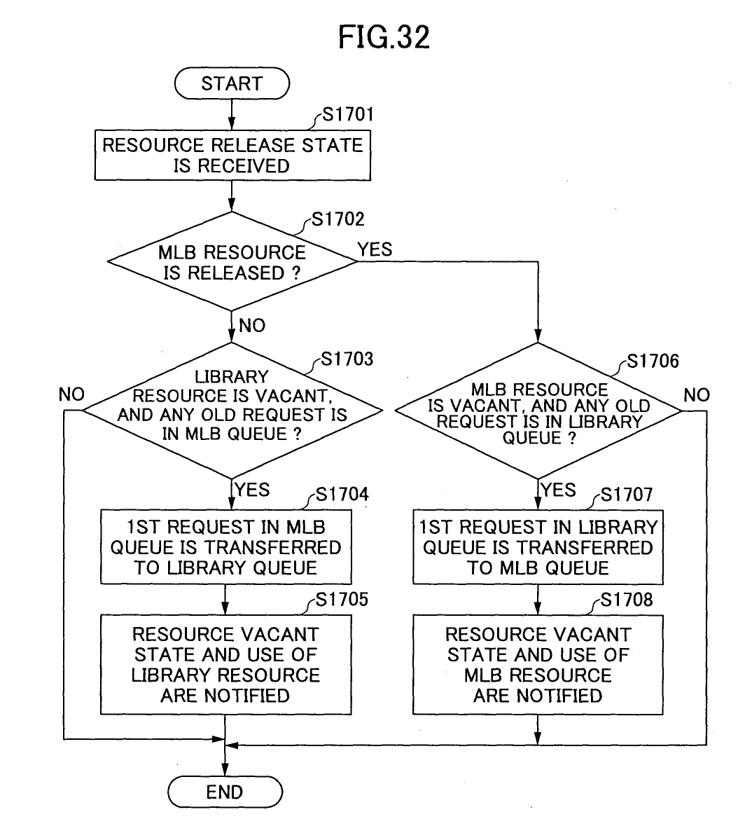

A description will be given of the rearrangement processing of the queue explained above, with reference to FIG. 32.

FIG. 32 is a flowchart for explaining processing of the resource management unit 46 when receiving the state of the resource releasing of the run thread 50.

At step S1701, the resource management unit 46 receives the state of releasing of the resource from the run thread 50.

At step S1702, the resource management unit 46 determines whether the resource released is the resource of MLB 43.

When the resource released is the resource of the transform library 51, the resource management unit 46, at step S1703, determines whether the resource of the transform library 51 is vacant and there is any waiting in the queue of MLB 43.

When it is determined at step S1703 that there is no waiting in the queue of MLB 43, the resource management unit 46 ends the rearrangement processing.

When it is determined at step S1703 that the resource of the transform library 51 is vacant and waiting is in the queue of MLB 43, the resource management unit 46, at step S1704, transfers the first request, which is stacked at the head end of the queue of MLB 43 with the turn of the image data processed at the beginning, to the queue of the transform library 51.

At step S1705, the resource management unit 46 notifies to the run thread 50 (which is in the resource waiting state) of the resource vacant state and the use of the resource of the transform library 51 (rather than the use of the resource of MLB 43). Then, the resource management unit 46 ends the rearrangement processing.

On the other hand, when it is determined at step S1702 that the resource released is the resource of MLB 43, the resource management unit 46, at step S1706, determines whether the resource of MLB 43 is vacant and there is any waiting in the queue of the transform library 51.

When it is determined at step S1706 that the resource of the transform library 51 is also vacant, the resource management unit 46 ends the rearrangement processing.

When it is determined at step S1706 that the resource of MLB 43 is vacant and waiting is in the queue of the transform library 51, the resource management unit 46, at step S1707, transfers the first request, which is stacked at the head end of the queue of the transform library 51 with the turn of the image data processed at the beginning, to the queue of MLB 43.

At step S1708, the resource management unit 46 notifies to the run thread 50 (which is in the resource waiting state) of the resource vacant state and the use of the resource of MLB 43 (rather than the use of the resource of the transform library 51). Then, the resource management unit 46 ends the rearrangement processing.

Moreover, there are several variations of the method of rearrangement in the above-described flowchart, which will be described below.

In the following description, the process-type and the utility-type will be used. The process-type means the processing accompanied by mechanical operation, such as optical reading operation of the scanner. This processing requires real-time operation, and high priority is assigned for this processing. Moreover, the utility-type means the processing which does not require real-time operation so much. Hence, low priority is assigned for the utility-type processing.

Thus, in the resource management unit 46, the image data to be transformed are classified into the two kinds of the process-type and the utility-type in advance.

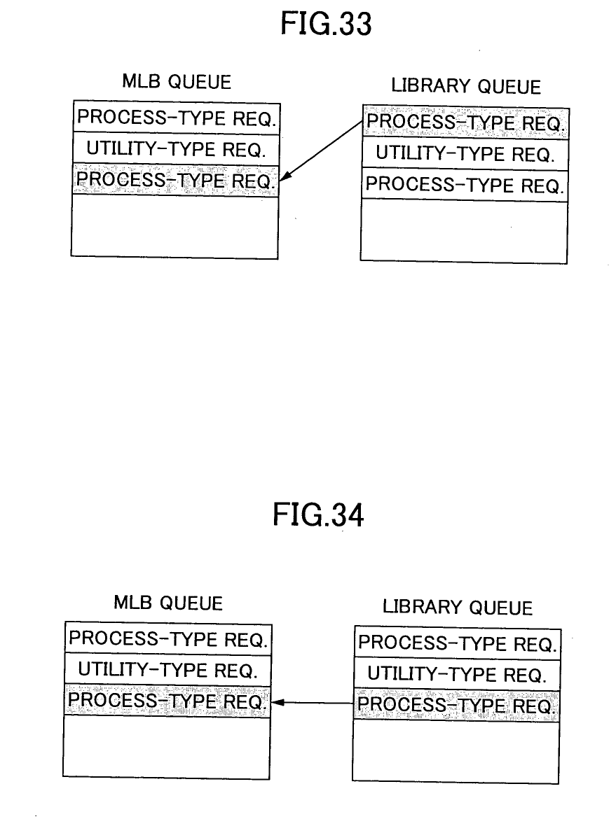

A description will be given of the first pattern of the rearrangement method with reference to FIG. 33.

FIG. 33 shows a method of rearrangement of image data in the queue. In the case of the method of FIG. 33, after the transforming of the preceding image data in the queue of MLB 43 is done, the resource management unit 46 transfers the first request (or the turn of the image data) stacked at the head end of the queue of the transform library 51 into the tail end of the queue of MLB 43.

Thus, it is possible for the method of the present embodiment to process the image data transformation at high speed by rearranging the transforming of the image data of the process-type with the high priority into the tail end of the queue of MLB 43.

Next, the 2nd pattern is explained using FIG. 34.

FIG. 34 is the view in which the resource management unit 46 shows rearranging into the tail end of the queue of MLB 43 the turn of the image data managed in the tail end of the queue of the transform library 51, and managing it after the transformation of the image data managed by the queue of MLB 43 is completed.

Thus, it becomes possible by rearranging the transforming of the image data of the process-type with the high priority into the tail end of the queue of MLB 43 to process at high speed.

Next, the 3rd and the 4th patterns will be explained using the table of FIG. 23.

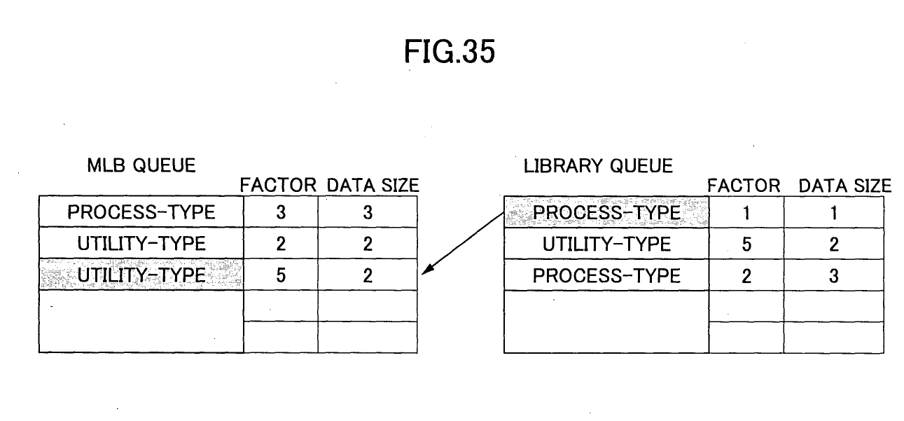

The 3rd pattern is explained using FIG. 35.

The 3rd pattern is rearrangement of the image data with the largest transform amount.

As shown in FIG. 35, at the queue of the transform library 51, the factor is 5 and the data size of the thing with the largest transform amount is the image data of the utility-type of 2.

The turn of this image data is rearranged into the tail end of the queue of MLB 43.

By doing in this way, when transform amount performs the large image data by MLB 43 in which high-speed processing is possible, the efficiency of the transforming can be increased.

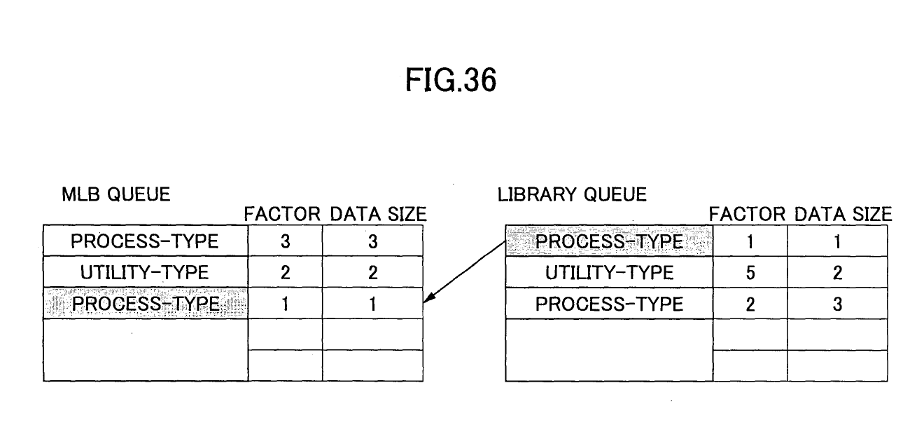

The 4th pattern is explained using FIG. 36.

The 4th pattern is rearrangement of the image data with the smallest transform amount.

As shown in FIG. 36, at the queue of the transform library, the factor is 1 and the data size of the thing with the smallest transform amount is the image data of the process-type of 1.

The turn of this image data is rearranged into the tail end of the queue of MLB 43.

By doing in this way, when transform amount performs the large image data by MLB 43 in which high-speed processing is possible, the efficiency of the transforming can be increased.

Thus, the resource management unit 46 rearranges the turn of managing the turn of the image data into the data format of the image data, the data format from which the image data is transformed, and the size of the image data based on the value.

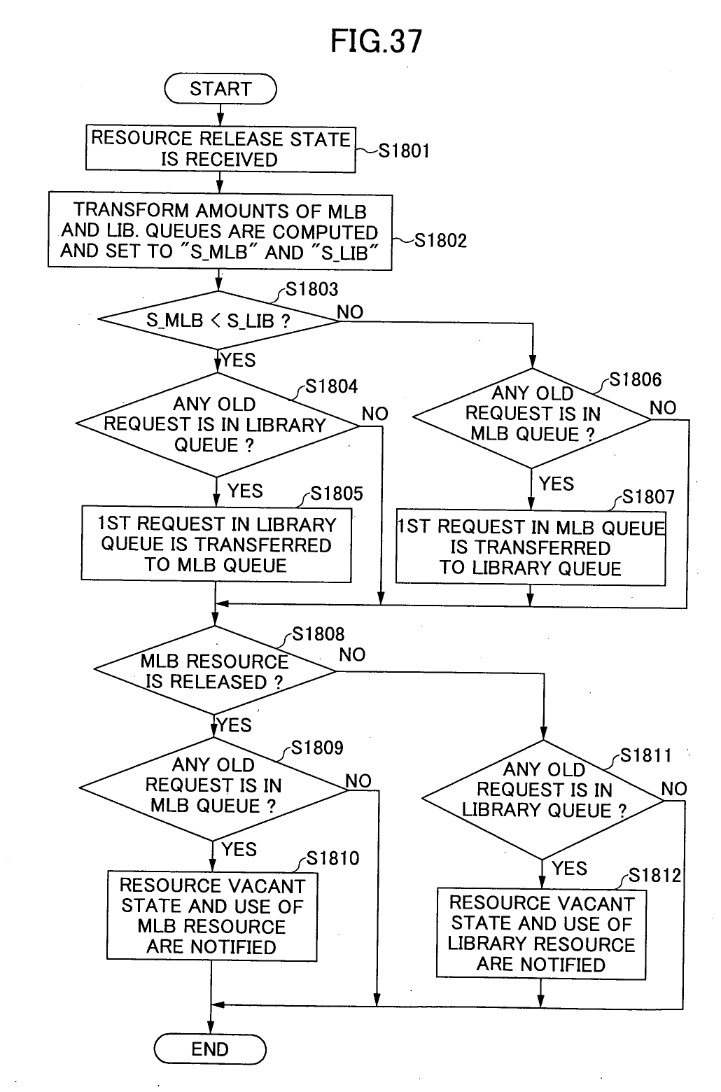

Next, processing rearranged based on the total of the transform amount of the image data managed at the queue using FIG. 37, respectively is explained.

At step S1801, the resource management 49 receives having released the resource from the run thread 48.

At step S1802, the resource management 49 calculates the total of the transform amount of the queue of MLB 43 and the transform library 51.

The method of calculation of the total of the transform amounts of the image data is the same as that described above with reference to FIG. 24.

As shown in FIG. 24, the queue of MLB 43 is 123 and, as for each total, the queue of the transform library becomes 114.

At step S1802, these values of 123 and 114 are calculated.

At this time, the resource management unit 46 substitutes the total transform amount of the queue of MLB 43 for the variable S_MLB, and substitutes the total transform amount of the queue of the transform library 51 for the variable S_LIB.

At step S1803, the resource management unit 46 compares the value of S_MLB and S_LIB.

When S_MLB is more than S_LIB, processing is advanced to step S1806 and it determines whether the image data of waiting is in the queue of MLB 43.

When there is no image data of waiting, the resource management unit 46 advances processing to step S1808.

When there is the image data of waiting, the resource management unit 46 is step S1807, is rearranged by moving the image data managed at the head end of the queue of MLB 43 to the queue of the transform library 51, and advances processing to step S1808.

It returns to processing of step S1803, when S_MLB is smaller than S_LIB, processing is advanced to step S1804, and it determines whether the image data of waiting is in the queue of the transform library 51.

When there is no image data of waiting, the resource management unit 46 advances processing to step S1808.

When there is the image data of waiting, the resource management unit 46 is step S1805, is rearranged by moving the image data managed at the head end of the queue of the transform library 51 to the queue of MLB 43, and advances processing to step S1808.

The above-described processing up to step S1807 is the rearrangement processing of image data. The following processing starting from step S1808 is the processing which notifies that the resource is vacant to the run thread 50.

At step S1808, the resource management unit 46 determines whether the released resource is MLB 43.

When the released resource is MLB 43, the resource management unit 46 is step S1809, it determines whether the image data of waiting is in the queue of MLB 43, and processing is ended when there is no image data of waiting.

When there is the image data of waiting, the resource management unit 46 is step S1810, notifies that the resource was vacant and transforming by MLB 43 to the run thread 50 which transforms the image data managed at the head end of the queue of MLB 43, and ends processing.

It returns to processing of step S1808, when the released resource is the transform library 51, the resource management unit 46 is step S1811, it determines whether the image data of waiting is in the queue of the transform library 51, and processing is ended when there is no image data of waiting.

When there is the image data of waiting, the resource management unit 46 is step S1812, notifies that the resource was vacant and transforming in the transform library 51 to the run thread 50 which transforms the image data managed at the head end of the queue of the transform library 51, and ends processing.

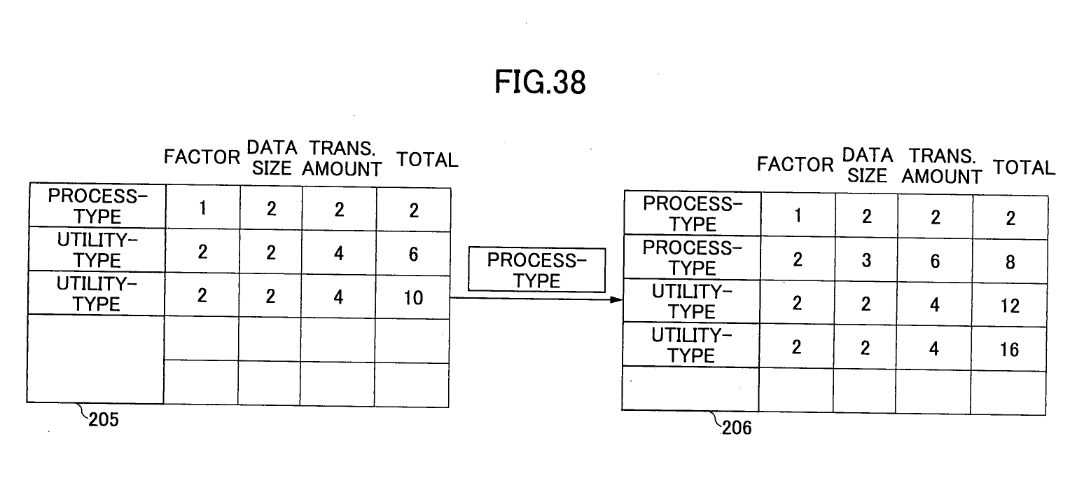

Next, the turn of the image data belonging to the process-type is explained using FIG. 38 about the processing made to interrupt in order of the image data already managed by the queue.

The two queues 205 and 206 are shown in FIG. 38, and the queue with which the image data of the process-type was further added to the queue 205 is the queue 206.

Moreover, at this queue, the factor of the corresponding image data, data size, transform amount, and the total are described.

The factor is the same as the factor shown in FIG. 23.

For example, as for the image data of the process-type at the head end of the queue 205, the count is 1, the data size is 2, the transform amount is 2, so that the total becomes 2.

In addition, this total is the total of the transform amounts of the image data managed by the queue.

For example, the total to the 2nd utility-type is set to 6 which added the transform amount 2 of the 1st process-type, and the transform amount 4 of the 2nd utility-type.

Thus, the total is the total of the transform amounts of the image data.

The conditions made to interrupt are defined using this total.

Specifically, it is determined that it is said that the total of transform amount wedges the image data of the process-type into descending watch most among five or less turn.

Suppose that the image data of the process-type is managed to the basis of the condition, and the state of control of the queue 205.

When it does so, the total of five or less turn is No. 1 or No. 2 at the queue 205.

Then, as shown in the queue 206, the turn of the image data of the newly managed process-type is five or less turn, and becomes settled with No. 2 which is the larger number below 5.

Thus, the turn made to interrupt is defined based on the data format from which the data format of the image data managed by the queue, data size, and the image data are transformed.

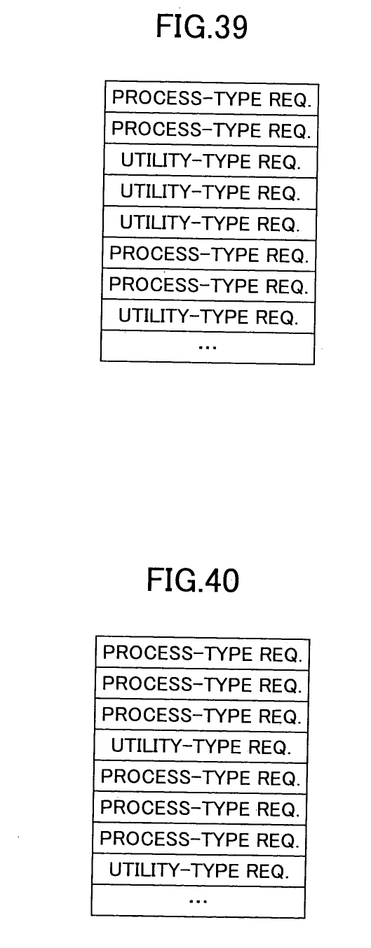

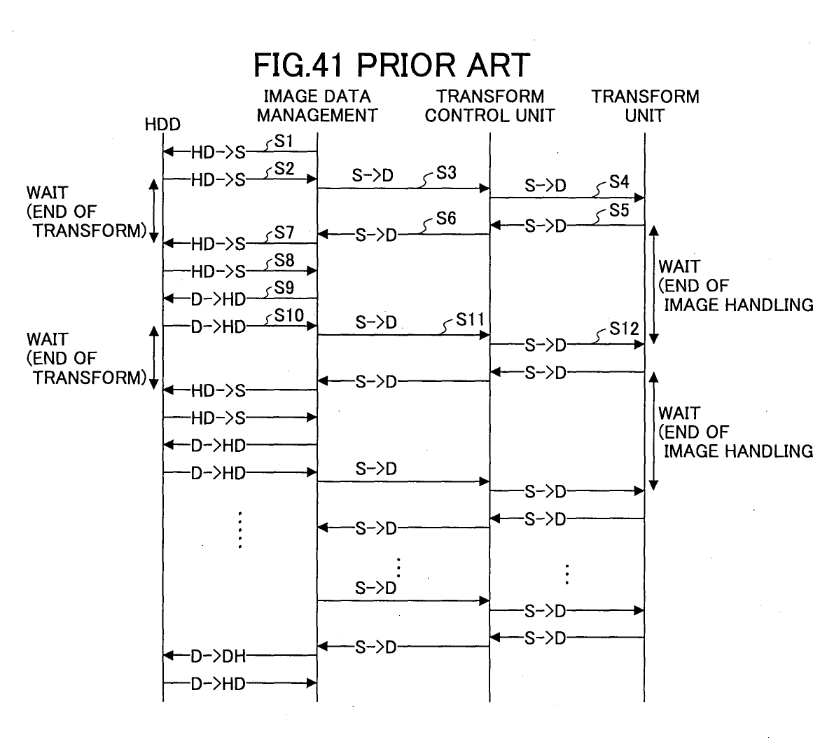

Next, it explains managing the turn that the image data belonging to the same kind is managed in the queue, in the turn made to continue one or more using FIG. 39 and FIG. 40.

FIG. 39 makes the image data of the process-type continue to two, and is the view showing managing the image data of the utility-type continuously to three.

Moreover, FIG. 40 makes the image data of the process-type continue to three, and is the view showing managing the image data of the utility-type continuously to one.

Thus, the resource management unit 46 is managed in the turn which one or more turn that the image data belonging to one kind is managed in the queue was made to follow.

Thus, when there is interruption by managing, it can prevent transforming only the image data of the same kind.

The present invention is not limited to the above-described embodiments, and variations and modifications may be made without departing from the scope of the present invention.

Further, the present invention is based on Japanese priority application No. 2002-235035, filed on Aug. 12, 2002, Japanese priority application No. 2002-276678, filed on Sep. 24, 2002, Japanese priority application No. 2002-276679, filed on Sep. 23, 2002, Japanese priority application No. 2003-203079, filed on Jul. 29, 2003, the entire contents of which are hereby incorporated by reference.

What is claimed is

1. An image forming apparatus comprising:
a plurality of hardware resources provided for use in image formation;
a plurality of programs performing respective processing related to the image formation;
an image-data transforming unit transforming source image data into destination image data;
an image-data memory unit having a source area in which the source image data is stored and a destination area in which the destination image data is stored; and
an image-data management unit storing the source image data into the image-data memory unit,
wherein the image forming apparatus is configured so that while the image-data transforming unit transforms a preceding source image data stored in the image-data memory unit, the image-data management unit stores a following source image, subsequently transformed by the image-data transforming unit, into the image-data memory unit.

2. The image forming apparatus according to claim 1 wherein the image forming apparatus is configured so that while the image-data transforming unit stores a following destination image data into the image-data memory unit, the image-data management unit saves a preceding destination image data, stored in the image-data memory unit, to an external storage device.

3. The image forming apparatus according to claim 1 wherein the image-data memory unit comprises a plurality of source areas and a plurality of destination areas.

4. The image forming apparatus according to claim 3 wherein after a preceding source image data is stored in one of the source areas, the image-data management unit stores a following source image data into another of the source areas when said another of the source areas are available.

5. The image forming apparatus according to claim 1 further comprising an external storage device for storing image data, wherein the image-data management unit is provided to store the image data, stored in the external storage device, into the image-data memory unit, and provided to save the transformed image data from the image-data memory unit to the external storage device.

6. The image forming apparatus according to claim 1 wherein the image-data transforming unit comprises a transforming unit which performs the transforming of image data, and a transformation control unit which controls the transforming unit.

7. The image forming apparatus according to claim 1 wherein the image forming apparatus comprises a plurality of image-data transforming units, each of the plurality of image-data transforming units comprising: a transforming unit which performs the transforming of image data; and a transformation control unit which controls the transforming unit.

8. The image forming apparatus according to claim 7 wherein at least one of the plurality of image data transforming units performs the transforming of image data by hardware, and at least one of the plurality of image transforming units performs the transforming of image data by software.

9. The image forming apparatus according to claim 8 further comprising a transformation management unit which selects one of the plurality of image-data transforming units, in order for the selected image-data transforming unit to perform the transforming of image data.

10. The image forming apparatus according to claim 9 wherein the transformation management unit selects one of the plurality of image-data transforming units based on a size of the image data or a data format of the image data.

11. The image forming apparatus according to claim 9 wherein the transformation management unit selects one of the plurality of image-data transforming units based on a data format of the transformed image data.

12. The image forming apparatus according to claim 8 wherein the transformation management unit manages a sequence of the transforming of the image data by the plurality of image-data transforming units, by using a queue provided for each of the plurality of image-data transforming units.

13. The image forming apparatus according to claim 12 wherein the image data are classified into two or more kinds, and the transformation management unit manages the sequence of the transforming of the image data by rearranging the order of the image data stacked in the queue according to the kinds of the image data.

14. The image forming apparatus according to claim 13 wherein the rearrangement of the order of the image data in the queue is determined based on a size or a data format of the image data stacked in the queue.

15. The image forming apparatus according to claim 13 wherein the rearrangement of the order of the image data in the queue is determined based on a data format of the transformed image data.

16. The image forming apparatus according to claim 12 wherein the transformation management unit manages the order of the image data in the queue that belong to one of a plurality of kinds, in accordance with a continuous sequence.

17. The image forming apparatus according to claim 12 wherein, after the transforming of the image data stacked in one of the queues for the plurality of image-data transforming units is completed, the transformation management unit rearranges the sequence of the image data in said one of the queues, based on a size or a data format of the image data stacked in another of the queues.

18. The image forming apparatus according to claim 12 wherein, after the transforming of the image data stacked in one of the queues for the plurality of image-data transforming units is completed, the transformation management unit rearranges the sequence of the image data in said one of the queues, based on a data format of the transformed image data in another of the queues.

19. The image forming apparatus according to claim 12 wherein, after the transforming of the image data stacked in one of the queues for the plurality of image-data transforming units is completed, the transformation management unit transfers a sequence of the image data at a head end of another of the queues to a tail end of said one of the queues.

20. The image forming apparatus according to claim 12 wherein, after the transforming of the image data stacked in one of the queues for the plurality of image-data transforming units is completed, the transformation management unit transfers a sequence of the image data at a tail end of another of the queues to a tail end of said one of the queues.

21. An image data transforming method for an image forming apparatus including a plurality of hardware resources provided for use in image formation and a plurality of programs performing respective processing related to the image formation, comprising the steps of:
providing an image-data memory unit having a source area in which source image data is stored and a destination area in which destination image data is stored;
storing the source image data into the image-data memory unit;
transforming the source image data stored in the image-data memory unit, into the destination image data;
wherein the storing step and the transforming step are configured so that while a preceding source image data stored in the image-data memory unit is transformed, a following source image, subsequently transformed by the transforming step, is stored into the image-data memory unit.

22. An image data transforming method for an image forming apparatus including a plurality of hardware resources provided for use in image formation and a plurality of programs performing respective processing related to the image formation, comprising the steps of:
providing an image-data memory unit having a source area in which source image data is stored and a destination area in which destination image data is stored;
storing the destination image data into the image-data memory unit; and
saving the destination image data stored in the image-data memory unit to an external storage device,
wherein the storing step and the saving step are configured so that while a following destination image data is stored into the image-data memory unit, a preceding destination image data, stored in the image-data memory unit, is saved to the external storage device.

23. An image data transforming method for an image forming apparatus including a plurality of hardware resources provided for use in image formation and a plurality of programs performing respective processing related to the image formation, comprising the steps of:
providing a plurality of image-data transforming units, each transforming image data;
selecting one of the plurality of image-data transforming units before the transforming of the image data; and
causing the selected image-data transforming unit to perform the transforming of the image data.

24. An image data transforming method for an image forming apparatus including a plurality of hardware resources provided for use in image formation and a plurality of programs performing respective processing related to the image formation, comprising the steps of:
providing a plurality of image-data transforming units, each transforming image data;
providing a queue for each of the plurality of image-data transforming units;
managing a sequence of the transforming of the image data by the plurality of image-data transforming units by using the respective queues of the plurality of image-data transforming units; and
rearranging a sequence of the image data stacked in one of the queues of the plurality of image-data transforming units.
